(19) United States
(12) Patent Application Publication
(10) Pub. No.: US 2007/0189242 A1
(43) Pub. Date: Aug. 16, 2007

(54) Wireless communication device and wireless communication method

(76) Inventors: Shuya Hosokawa, Osaka (JP); Koichiro Tanaka, Hyogo (JP)

Correspondence Address: WENDEROTH, LIND & PONACK L.L.P., 2033 K. STREET, NW, SUITE 800, WASHINGTON, DC, 20006, US

(21) Appl. No.: 10/591,747

(22) PCT Filed: Apr. 1, 2005
(86) PCT No.: PCT/JP05/06477

§ 371 Date: Sep. 6, 2006

(30) Foreign Application Priority Data
Apr. 5, 2004 (JP) 2004-110830

(51) Int. Cl. H04Q 7/24

(52) U.S. Cl. 370/338

(57) ABSTRACT

When a wireless communication apparatus is used indoors where discharge lamps are used, flickering of the discharge lamp can cause transmission path fluctuations in which the amplitude or phase of the reception signal changes suddenly. The effect of this discharge lamp fading is that communication data errors occur easily and communication quality drops. A wireless communication apparatus according to the present invention has a transmission path fluctuation period detection unit (101) that detects the period in which transmission path fluctuation caused by discharge lamp increases, a transmission control unit (102) that sets transmission signal conditions based on the detected transmission path fluctuation period, a transmission unit (103) that generates and outputs the transmission signal based on these conditions, and an antenna (104) for transmitting the transmission signals. The wireless communication apparatus thus comprised stops wireless signal transmission during the transmission path fluctuation period or transmits a wireless signal that is resistant to data errors caused by change in the transmission path environment.

### BACKGROUND OF THE INVENTION

The present invention relates to a wireless LAN or other wireless communication device or apparatus, and to a wireless communication method for the same.

Local area networks (LAN) are increasingly common both in business and in the home, including wireless LANs that do not require wiring and allow free movement of the data terminals connected to the LAN.

In a typical wireless LAN such as used today a wireless LAN control device (referred to as a “wireless access point” below) is connected by wire to a data socket, and a plurality of wireless LAN terminals communicate wirelessly with this wireless access point.

Sudden changes in the wireless communication environment caused by fluorescent lights and other discharge lamps in wireless communication systems that are used indoors can easily generate communication data errors, thus degrading communication quality.

A discharge lamp reflects radio frequency waves in the wireless communication path when the discharge lamp is discharging but passes the waves when the discharge lamp is not discharging. As a result, the amplitude and phase of RF signals passing the discharge lamp differ during these two periods, that is, when the discharge lamp is discharging and is not discharging. This fading of the RF signal caused by the discharge lamp is referred to herein as “discharge lamp fading.”

Patent reference 1 cited below teaches a method of installing a wireless communication device used as an access point to a fluorescent light or other lighting fixture using the fact that obstructions are not present between all communicating wireless LAN terminals and power supply wiring is not needed, but discharge lamp fading has an even greater effect in such cases.

Patent reference 2 cited below teaches an automatic gain control device for reducing the effect of this discharge lamp fading. The invention taught in patent reference 2, however, focuses on the fact that fluctuation in the received field strength of the received signal due to discharge lamp fading depends on the power supply frequency and has a regular period, therefore stores information relating to field strength fluctuation in said period, and based thereon automatically controls the gain.

[Patent reference 1] Japanese Utility Model Application H06-31286

[Patent reference 2] Japanese Unexamined Patent Application H08-23335

[Patent reference 3] Japanese Unexamined Patent Application H08-186456

### SUMMARY OF THE INVENTION

Communication errors cannot be sufficiently reduced by automatic gain control alone, however, because both the amplitude and the phase of the received signal vary in a transmission path environment subject to discharge lamp fading. In addition, the in-band frequency pass characteristics also change due to discharge lamp fading in the transmission of OFDM signals and other broadband signals. Reducing the effect of discharge lamp fading using only automatic gain control is thus difficult.

To resolve the foregoing problem of the prior art, an object of the present invention is to provide a wireless communication apparatus that can avoid communication data error and achieve stable throughput even when there is sudden change in the wireless communication path due to discharge lamp fading.

To resolve the foregoing problem of the prior art, a wireless communication apparatus according to the present invention has a transmission path fluctuation period detection unit for detecting a period in which fluctuation in the wireless communication path caused by a discharge lamp is greater than other periods, a transmission control unit for controlling the transmission signal based on the detected transmission path fluctuation period, a transmission unit for outputting the set transmission signal, and an antenna for transmitting the transmission signal. A wireless communication apparatus according to the present invention thus comprised either stops transmitting the wireless signal in the transmission path fluctuation period or transmits a wireless signal that is resistant to errors caused by change in the transmission path environment.

The present invention thus makes it possible to avoid data errors in the reception-side wireless terminal, and makes it possible to prevent a drop in communication quality. The number of times data must be retransmitted can therefore be reduced, and stable throughput can be achieved.

### BRIEF DESCRIPTION OF THE DRAWINGS

FIG. 1 is a signal waveform diagram describing the basic concept of the present invention;

FIG. 2A is a block diagram of a wireless communication apparatus according to a first embodiment of the invention;

FIG. 2B is a block diagram of a specific configuration of the transmission path fluctuation period detection unit shown in FIG. 2A according to a first embodiment of the invention;

FIG. 2C is a block diagram of the transmission control unit shown in FIG. 2A according to a first embodiment of the invention;

FIG. 2D is a first internal signal waveform diagram in a wireless communication apparatus according to a first embodiment of the invention;

FIG. 3A is a waveform diagram of a signal describing the basic concept of the present invention;

FIG. 3B is a second internal signal waveform diagram in a wireless communication apparatus according to a first embodiment of the invention;

FIG. 4A is a block diagram of a wireless communication apparatus according to a second embodiment of the present invention;

FIG. 4B is a block diagram of the transmission path fluctuation period detection unit shown in FIG. 4A according to a second embodiment of the invention;

FIG. 5 is an internal signal waveform diagram for a wireless communication apparatus according to a second embodiment of the present invention;

FIG. 6A is a block diagram of a wireless communication apparatus according to a third embodiment of the present invention;

FIG. 6B is a block diagram of the transmission path fluctuation period detection unit shown in FIG. 6A according to a third embodiment of the present invention;

FIG. 7A is an internal signal waveform diagram for a wireless communication apparatus according to a third embodiment of the present invention;

FIG. 7B is an internal signal waveform diagram for a wireless communication apparatus according to a third embodiment of the present invention;

FIG. 7C is an internal signal waveform diagram for a wireless communication apparatus according to a third embodiment of the present invention;

FIG. 8A is a block diagram of a wireless communication apparatus according to a fourth embodiment of the invention;

FIG. 8B is a block diagram of the transmission path fluctuation period detection unit shown in FIG. 8A in a fourth embodiment of the invention;

FIG. 9 is an internal signal waveform diagram for a wireless communication apparatus according to a fourth embodiment of the present invention;

FIG. 10A is a block diagram of a wireless communication apparatus according to a fifth embodiment of the invention;

FIG. 10B is a block diagram of the transmission path fluctuation period detection unit shown in FIG. 10A according to a fifth embodiment of the invention;

FIG. 11 is an internal signal waveform diagram for a wireless communication apparatus according to a fifth embodiment of the present invention;

FIG. 12A is a block diagram of a wireless communication apparatus according to a sixth embodiment of the invention;

FIG. 12B is a block diagram of the transmission control unit shown in FIG. 12A in a sixth embodiment of the invention;

FIG. 13 is an internal signal waveform diagram for a wireless communication apparatus according to a sixth embodiment of the present invention;

FIG. 14A is a block diagram of a wireless communication apparatus according to a seventh embodiment of the invention;

FIG. 14B is a block diagram of the transmission control unit shown in FIG. 14A according to a seventh embodiment of the invention;

FIG. 15 is an internal signal waveform diagram for a wireless communication apparatus according to a seventh embodiment of the present invention;

FIG. 16A is a block diagram of a wireless communication apparatus according to an eighth embodiment of the invention;

FIG. 16B is a block diagram of the transmission control unit shown in FIG. 16A according to an eighth embodiment of the invention;

FIG. 17 is an internal signal waveform diagram for a wireless communication apparatus according to an eighth embodiment of the present invention;

FIG. 18A is a block diagram of a wireless communication apparatus according to a ninth embodiment of the invention;

FIG. 18B is a block diagram of the transmission control unit shown in FIG. 18A according to a ninth embodiment of the invention;

FIG. 19 is an internal signal waveform diagram for a wireless communication apparatus according to a ninth embodiment of the present invention;

FIG. 20 is a map of a wireless packet transmitted from the wireless communication apparatus of the present invention to another wireless terminal in the ninth, tenth, and eleventh embodiments of the present invention;

FIG. 21A is a block diagram of a wireless communication apparatus according to a tenth embodiment of the invention;

FIG. 21B is a block diagram of the transmission control unit shown in FIG. 21A according to a tenth embodiment of the invention;

FIG. 22 is an internal signal waveform diagram for a wireless communication apparatus according to a tenth embodiment of the present invention;

FIG. 23 is a map of a wireless packet transmitted from another wireless terminal to the wireless communication apparatus of the present invention in a tenth embodiment of the present invention;

FIG. 24 is a state transition diagram of a first spatial channel in a tenth embodiment of the invention;

FIG. 25 is a state transition diagram of a second spatial channel in a tenth embodiment of the invention;

FIG. 26A is a block diagram of a wireless communication apparatus according to an eleventh embodiment of the invention;

FIG. 26B is a block diagram of the transmission control unit shown in FIG. 26A according to an eleventh embodiment of the invention;

FIG. 26C is a block diagram of the reception state detection unit shown in FIG. 26A according to an eleventh embodiment of the invention;

FIG. 27 is an internal signal waveform diagram for a wireless communication apparatus according to an eleventh embodiment of the present invention;

FIG. 28 is a state transition diagram of a first spatial channel in an eleventh embodiment of the invention; and

FIG. 29 is a state transition diagram of a second spatial channel in an eleventh embodiment of the invention.

### KEY TO THE FIGURES

101 transmission path fluctuation period detection unit
102 transmission control unit
103 transmission unit
104 antenna
105 AC power supply meter
106 photoelectric conversion unit
107 transmission/reception switch
108 reception unit
109 periodic signal generator
110 wireless terminal
111 normal transmission confirmation unit
112 transmission rate controller
113 multirate modulator
114 destination terminal selection control unit
115 wireless terminal A
116 wireless terminal B
117 spatial multiplex level control unit
118 spatial multiplexer
119 transmission mode control unit
120 multimode modulator
121 reception state detection unit
122 multi-antenna wireless terminal
123 internal transmission unit of a multi-antenna wireless terminal
124 internal reception state detection unit of a multi-antenna wireless terminal

### DETAILED DESCRIPTION OF THE PREFERRED EMBODIMENTS

The basic concept of the present invention is described first below before describing the preferred embodiments of the invention.

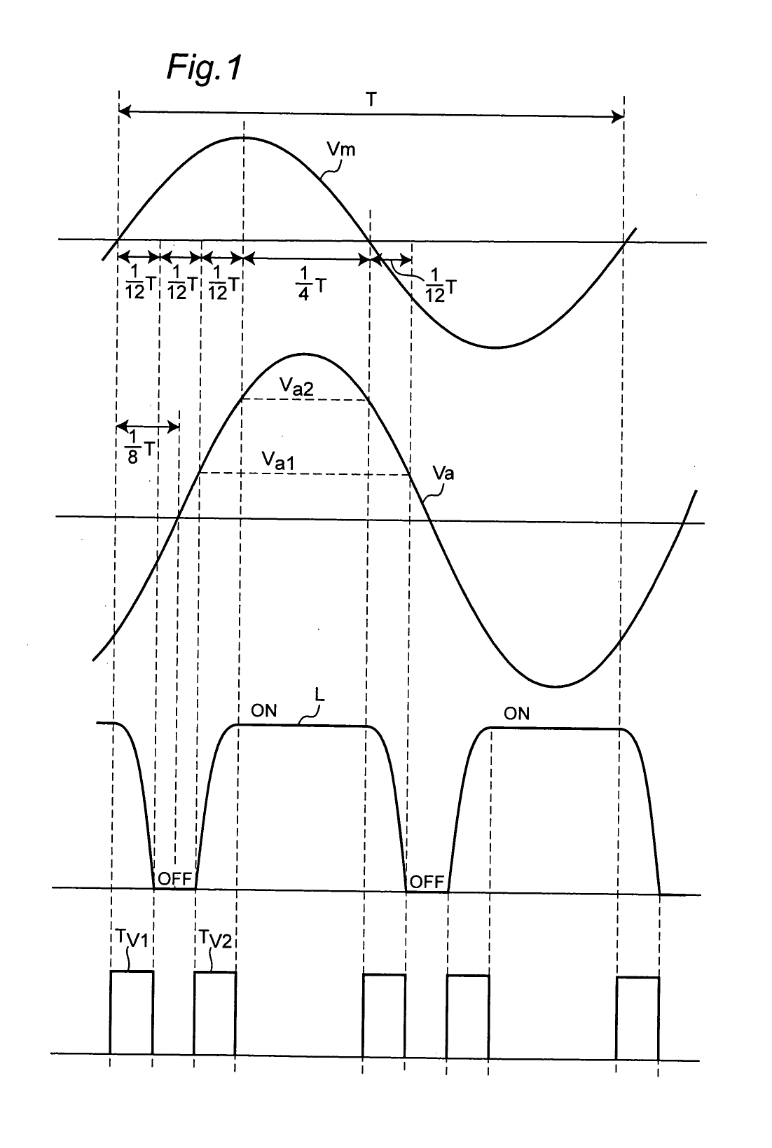

FIG. 1 shows the AC power supply voltage signal Vm, step-up signal Va which is the power supply voltage boosted by a step-up coil, lamp signal L denoting the on/off state of the discharge lamp, and transmission path fluctuation periods Tv1 and Tv2. Note that a discharge lamp as used herein includes fluorescent lamps and other types of discharge lamps that operate using power supplied from an AC power source, as well as other electrical devices that operate synchronized to an AC power source.

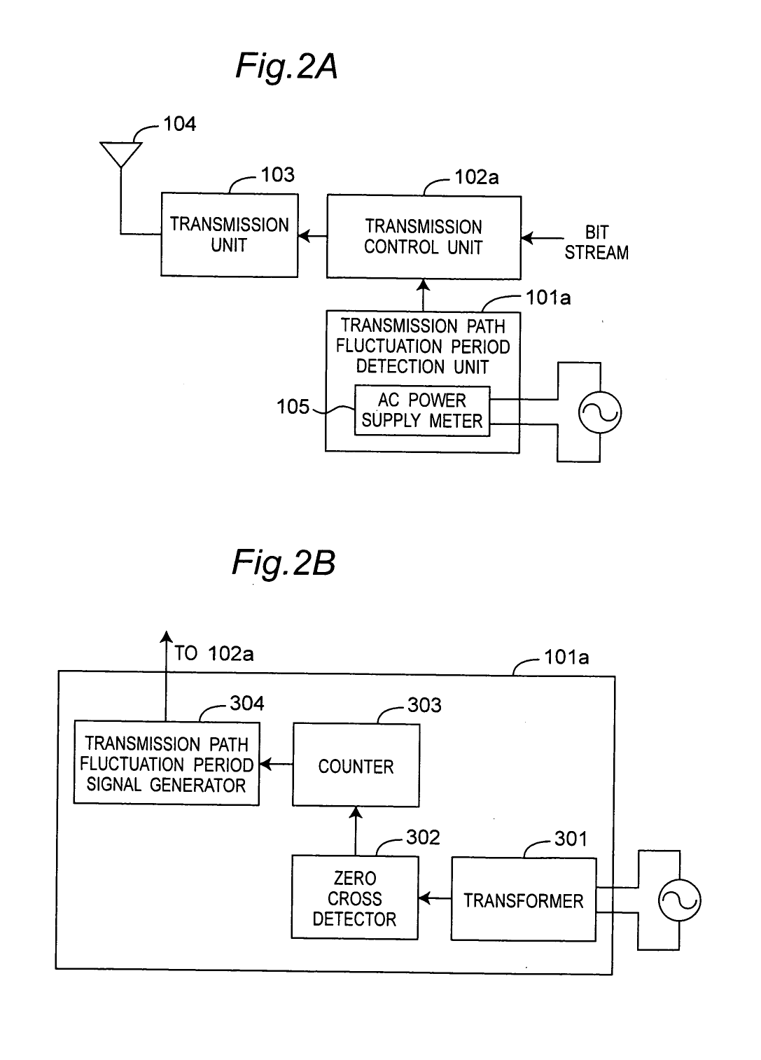

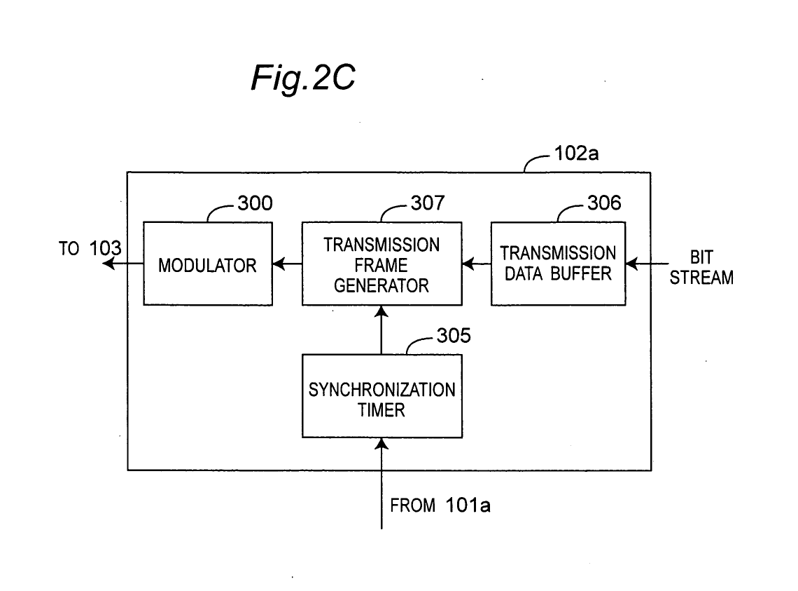

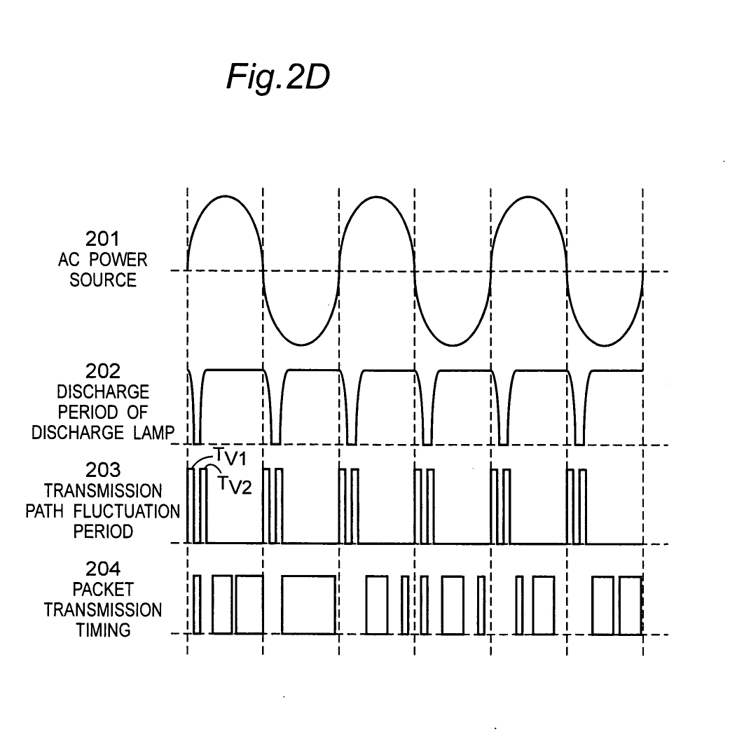

The phase of the step-up signal Va is delayed from the phase of the power supply voltage signal Vm by the step-up coil (transformer 301 shown in FIG. 2B.) This delay depends on the characteristics of the step-up coil, but is generally approximately (⅛)T where T is the period of one cycle of the power supply voltage signal Vm.

Change in the discharge lamp in the positive half cycle of the step-up signal Va is analyzed below. A discharge lamp to which step-up signal Va is applied starts to emit when the step-up signal Va crosses the zero cross point and rises to first specific voltage Va1, and reaches the rated output level when the step-up signal Va rises to second specific voltage Va2. Discharge lamp output begins to drop from the rated output level when the supply voltage then drops to or below second specific voltage Va2 and stops emitting altogether when the supply voltage drops below first specific voltage Va1. Output changes in the same way in the negative half cycle of the step-up signal Va.

The discharge lamp therefore turns on/off at a frequency that is twice the frequency of the AC power source. Based on this example, the following relationship exists between power supply voltage signal Vm and the on/off cycle of the discharge lamp.

The discharge lamp begins discharging at an approximately (⅙)T phase delay from the zero cross of the power supply voltage signal Vm. The discharge lamp reaches the rated output level at approximately ( 1/12)T after the lamp starts discharging. This time from when the lamp is off until the lamp reaches the rated output level is referred to as the “rising period.” The period in which this rated output level is held is approximately (¼)T, and is called the “discharge period.” The end point of the discharge period is substantially coincident to the next zero cross of the power supply voltage signal Vm. The period from rated output until the discharge lamp turns off is the “falling period.” This off state continues for approximately ( 1/12)T and is called the “off period.” The lengths of the off period, rising period, discharge period, and falling period described above are noted by way of example only and will vary according to the characteristics of the discharge lamp and the characteristics of the step-up coil. Note, however, that the falling period, off period, and rising period occur in the (¼)T period from the zero cross of the AC power source in most common discharge lamps.

The effect of a discharge lamp on the transmission path of a wireless LAN carrying a packetized bit stream in the falling period and rising period is an unstable transmission path. The discharge lamp works as an insulator when the lamp is off and passes RF signals, but works as a high loss dielectric that reflects and absorbs RF signals when the lamp is on. Therefore, when a discharge lamp is present in a wireless communication transmission path, the amplitude and phase of RF signals passing through the discharge lamp fluctuate in the falling period Tv1 and rising period Tv2, fading occurs as a result of the signals combining with signals carried on other transmission paths, and sharp fluctuations thus occur on the transmission path.

The RF signal reflection and absorption rate also changes due to variation in the discharge strength when the lamp is on, but the change in the RF signal reflection and absorption rate is small because the absolute value of the dielectric constant inside the discharge lamp is significantly greater than the dielectric constant of a vacuum. As a result, fluctuation in the transmission path is small during the relatively long discharge period, but transmission path fluctuation increases in the falling period Tv1 from the on state to the off state and in the rising period Tv2 from the off state to the on state. Periods Tv1 and Tv2 in which this fluctuation is great have a specific time relationship to voltage fluctuation in the line power.

The present invention therefore treats the period including at least this falling period and rising period as transmission path fluctuation periods Tv1 and Tv2, generates signals Tv1 and Tv2 for these periods, and during periods Tv1 and Tv2 either prohibits signal transmission or permits transmitting only signals that are resistant to the effect of the discharge lamp in these periods. More specifically, signals are transmitted in a restricted transmission mode that restricts packet transmission if the packet transmission period is coincident to any part of transmission path fluctuation period Tv1 or Tv2, and signals are transmitted in a normal transmission mode that does not restrict packet transmission if the packet transmission period is not coincident with transmission path fluctuation period Tv1 or Tv2.

Preferred embodiments of the present invention are described next below with reference to the accompanying figures.

### Embodiment 1

FIG. 2A is a block diagram of a wireless communication apparatus according to a first embodiment of the invention. In this embodiment of the invention the transmission path fluctuation period is period Tv1 from the zero cross of the AC power source to ( 1/12)T, and period Tv2 from (⅙)T to ( 1/12)T.

As shown in FIG. 2A, the wireless communication apparatus has a transmission path fluctuation period detection unit 101a, transmission control unit 102a, transmission unit 103, and antenna 104. The transmission path fluctuation period detection unit 101a has an AC power supply meter 105 and is connected to an external AC power source. The transmission path fluctuation period detection unit 101a outputs a fluctuation period signal indicating the transmission path fluctuation periods Tv1 and Tv2 as shown in FIG. 2D. The transmission control unit 102a receives the transmitted bit stream data and the fluctuation period signal, modulates the bit stream using QAM coding, for example, generates packets, and outputs the packets at a timing that avoids, that is, does not overlap, the transmission path fluctuation period. The transmission unit 103 outputs the packets from the transmission control unit 102 over a high frequency wireless signal. The wireless signal is transmitted from antenna 104.

FIG. 2B is a block diagram showing an example of the transmission path fluctuation period detection unit 101a shown in FIG. 2A. The transmission path fluctuation period detection unit 101a shown in FIG. 2B has a transformer 301, zero cross detector 302, counter 303, and transmission path fluctuation period signal generator 304. The transformer 301 is connected to an AC power source and generates step-up signal Va from power supply voltage signal Vm. The zero cross detector 302 detects the zero cross of step-up signal Va. A peak detector could be used instead of a zero cross detector. When the zero cross is detected, the counter 303 resets and starts counting again. The transmission path fluctuation period signal generator 304 generates the transmission path fluctuation period signal based on the count, and in this embodiment of the invention is set to output the transmission path fluctuation period signal for ( 1/12)T from the zero cross and for ( 1/12)T from (⅙)T after the zero cross. The transmission path fluctuation period signal is output to transmission control unit 102a.

The period T of the zero cross signal output by zero cross detector 302 is 1/100 second (when using a 50 Hz AC power source) or 1/120 second (when using a 60 Hz AC power source), and is synchronized to the transmission path fluctuation period of the discharge lamp, for example.

FIG. 2C is a block diagram showing an example of the transmission control unit 102a shown in FIG. 2A. As shown in FIG. 2A the transmission control unit 102a has a synchronization timer 305, transmission data buffer 306, transmission frame generator 307, and modulator 300.

The synchronization timer 305 receives the transmission path fluctuation period signal from the transmission path fluctuation period detection unit 101 shown in FIG. 1 and outputs how much time there is when there is no transmission path fluctuation until transmission path fluctuation occurs again. In this embodiment of the invention this is the period not including periods Tv1 and Tv2 shown in FIG. 2D. Note that the synchronization timer 305 could also be omitted depending upon the design.

The transmission data buffer 306 receives the bit stream to be transmitted and sequentially outputs the bit stream at the required timing. The transmission frame generator 307 receives the bit stream output by the transmission data buffer 306, generates the transmission frames, and packetizes the transmission frames based on the timing signal received from synchronization timer 305 so that data is transmitted during the periods when there is no transmission path fluctuation. The modulator 300 modulates the packetized data using a method such as QAM or PSK modulation. Other modulation methods could alternatively be used. The modulated data is then output to the transmission unit 103.

The transmission unit 103 shown in FIG. 2A transmits the modulated data over a wireless carrier signal from the antenna. The data is thus transmitted from the antenna when there is no transmission path fluctuation, and transmission data errors can thus be avoided.

In this first embodiment of the invention the transmission control unit 102a selects the restricted transmission mode in which transmission is prohibited if the packet transmission period will overlap transmission path fluctuation period Tv1 or Tv2, and selects the normal transmission mode in which data is transmitted normally when the packet transmission period will not overlap the transmission path fluctuation period.

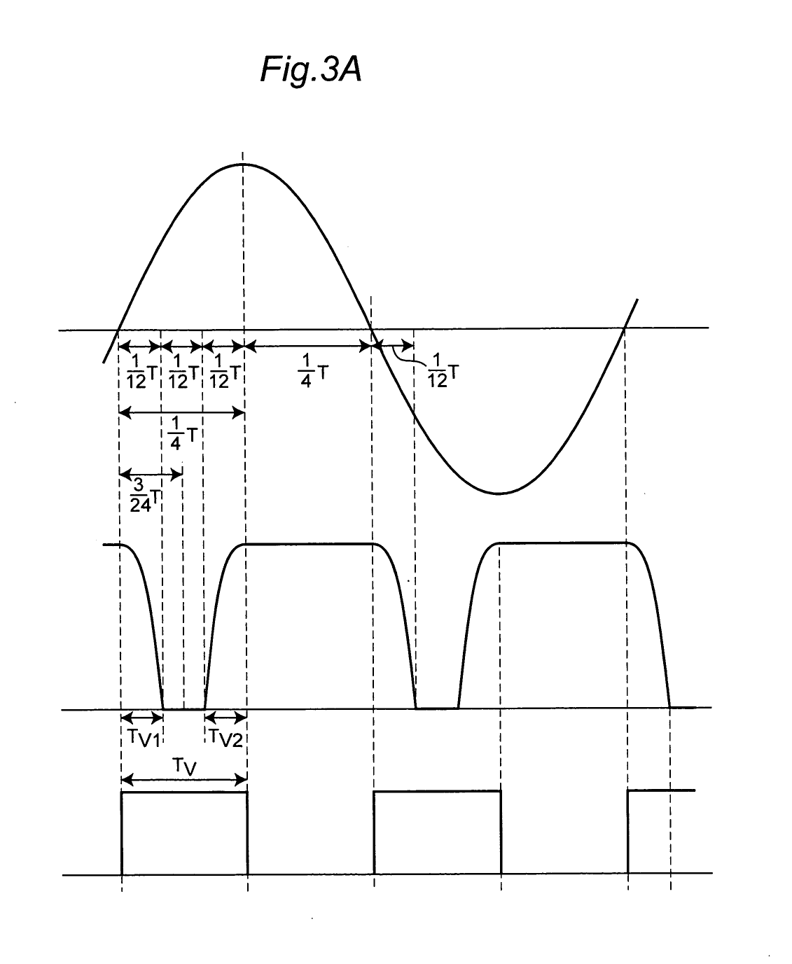

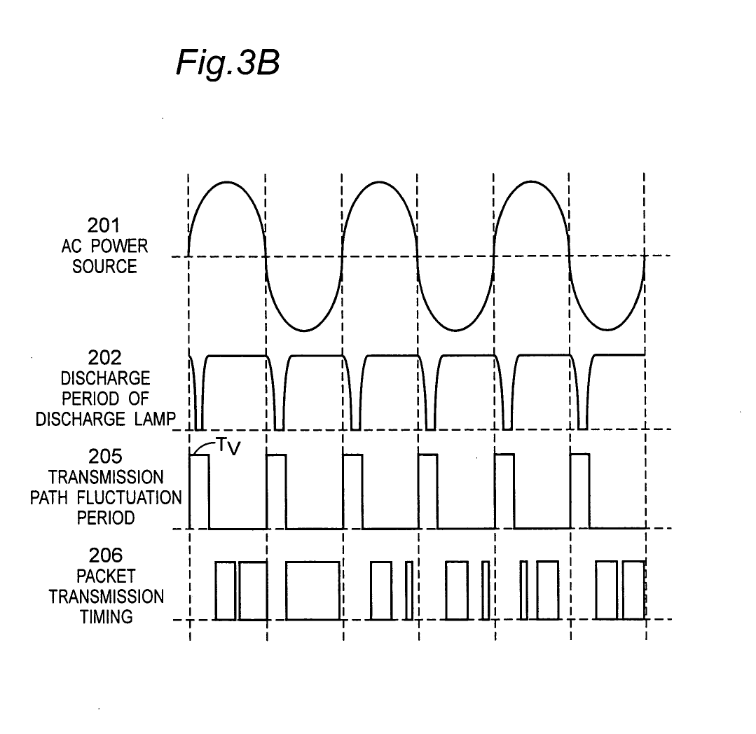

As described above, the wireless communication apparatus in this embodiment of the invention assumes that the falling period Tv1 in which the discharge lamp goes from on to off and the rising period Tv2 in which the discharge lamp goes from off to on as indicated by waveform 203 in FIG. 2D are the transmission path fluctuation period. Because the discharge period of the discharge lamp is longer than the off period, the transmission path fluctuation period could alternatively be the continuous period Tv shown in FIG. 3A and waveform 205 in FIG. 3B from when discharge lamp output begins to drop until lamp output rises to the rated output level again. This reduces the frequency of transmission signal control without greatly reducing the packet transmission time of the wireless communication apparatus. In this case the wireless communication apparatus transmits the wireless packets at any time other than transmission path fluctuation period Tv as shown in wveform 206 in FIG. 3B.

Because the timing of these sudden variations in the transmission path caused by the on/off cycle of the discharge lamp are synchronized to the frequency of the AC power source, a wireless communication apparatus according to this embodiment of the invention measures the period (zero cross to zero cross or peak to peak) and the phase of the AC power source. The wireless communication apparatus can estimate transmission path fluctuation based on the result and control the packet length and transmission timing of the data packets for transmission, and can thus avoid communication data errors caused by transmission path fluctuation induced by discharge lamps.

### Embodiment 2

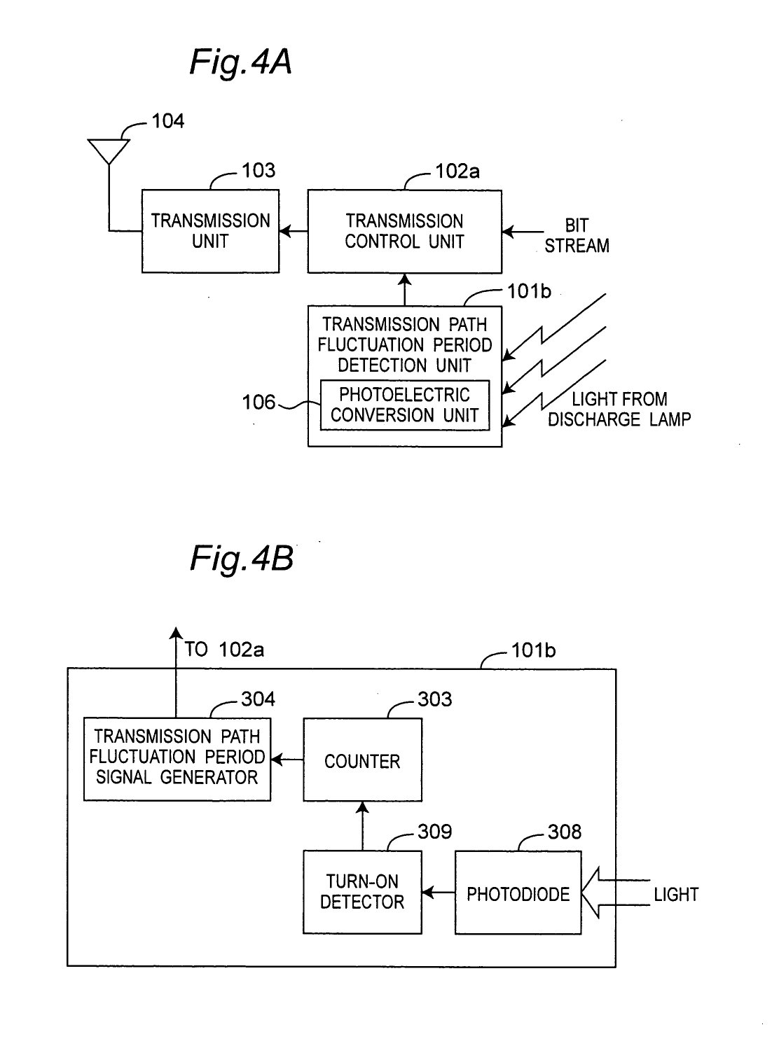

FIG. 4A is a block diagram showing the arrangement of a wireless communication apparatus according to a second embodiment of the invention.

As shown in FIG. 4A, a wireless communication apparatus according to this embodiment of the invention has a transmission path fluctuation period detection unit 101b, a transmission control unit 102a to which the transmission path fluctuation period signals Tv1 and Tv2 output by transmission path fluctuation period detection unit 101b are input, a transmission unit 103 to which the transmission signal output by transmission control unit 102a is input, and a antenna 104 connected to the transmission unit 103. A photoelectric conversion unit 106 is rendered inside the transmission path fluctuation period detection unit 101b.

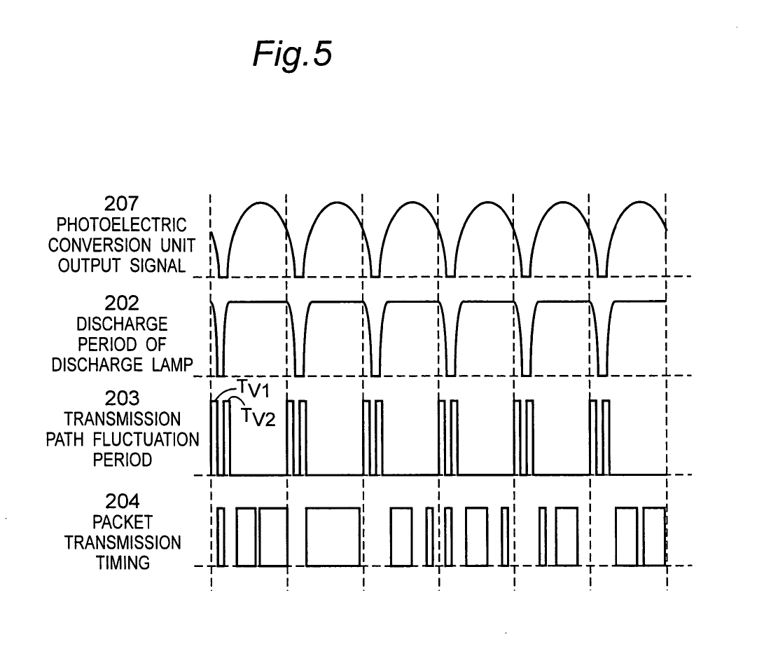

FIG. 5 is a waveform diagram with time on the horizontal axis describing the operation of the wireless communication apparatus according to this second embodiment of the invention.

Like elements and waveforms in FIG. 4A and FIG. 5 and in FIG. 2A and FIG. 2D according to the first embodiment described above are identified by like reference numerals, and further description thereof is omitted here.

In FIG. 5 the photoelectric conversion unit output signal 207 represents the electric signal output by the photoelectric conversion unit 106 from light received from the discharge lamp. This electric signal and the discharge period of the discharge lamp have a constant temporal relationship determined by the delay time of the photoelectric conversion unit 106 and the temporal relationship between discharge and light output by the discharge lamp.

FIG. 4B is a block diagram of the transmission path fluctuation period detection unit 101b shown in FIG. 4A. Like elements in FIG. 4B and the first embodiment shown in FIG. 2B are identified by like reference numeral, and further detailed description thereof is omitted here.

As shown in FIG. 4B, this transmission path fluctuation period detection unit 101b has an internal photodiode 308 which outputs an electric signal corresponding to the strength of the light detected by the photodiode 308. A turn-on detector 309 detects the rising edge of the electrical signal output by the photodiode 308 to detect the instant the discharge lamp begins to output light, and outputs to the counter 303. The period of the turn-on signal output by the turn-on detector is synchronized to the transmission path fluctuation period of the discharge lamp. Subsequent operation of the counter 303 and the transmission path fluctuation period signal generator is the same as described with reference to FIG. 2B in the foregoing first embodiment of the invention. Operation is controlled, for example, by using the ( 1/12)T period from turn-on detection as rising period Tv2, and the ( 1/12)T period starting from (⅓)T after turn-on detection as the falling period Tv1.

In a wireless communication apparatus according to this second embodiment of the invention, the transmission path fluctuation period detection unit 101b thus estimates the time in which the transmission path fluctuation period, which is in a constant time-based relationship to the electric signal, increases. Operation based on the transmission path fluctuation period signals Tv1 and Tv2 is the same as in the first embodiment. If the delay time of the photoelectric conversion device is known, the wireless communication apparatus of the present invention can detect the transmission path fluctuation period more accurately.

A wireless communication apparatus according to this second embodiment of the invention estimates the period Tv1 in which the discharge lamp goes from on to off and the period Tv2 in which the discharge lamp goes from off to on as shown in waveform 203 in FIG. 5 as the transmission path fluctuation period, but the transmission path fluctuation period could alternatively be the uninterrupted period from when discharge lamp output begins to decrease until output returns to the rated output level.

The wireless communication apparatus according to this embodiment of the invention thus uses a photoelectric conversion unit to measure the actual on and off periods of the discharge lamp. The wireless communication apparatus can then detect the transmission path fluctuation period based on these values, and by controlling the data packet transmission timing and packet length accordingly can avoid communication data errors caused by transmission path fluctuation induced by the discharge lamp.

### Embodiment 3

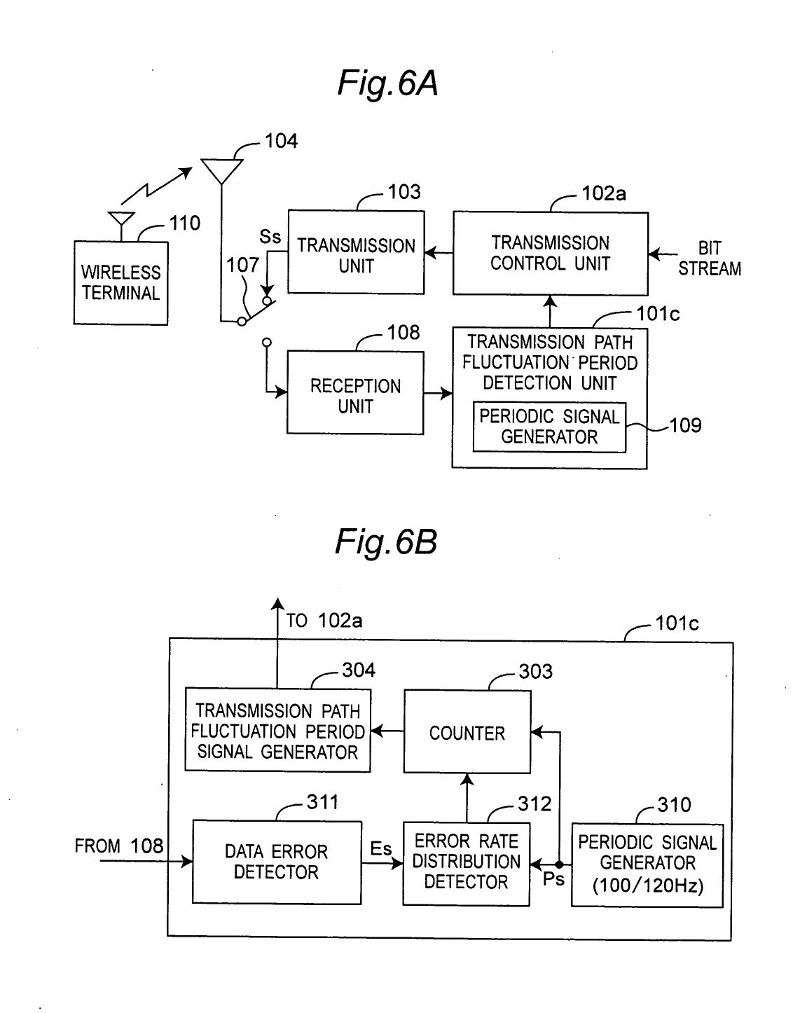

FIG. 6A is a block diagram showing the arrangement of a wireless communication apparatus according to a third embodiment of the invention.

As shown in FIG. 6A, a wireless communication apparatus according to this embodiment of the invention has a transmission path fluctuation period detection unit 101c, a transmission control unit 102a to which the transmission path fluctuation period signals Tv1 and Tv2 output by transmission path fluctuation period detection unit 101c are input, a transmission unit 103 to which the transmission signal output by transmission control unit 102a is input, a transmission/reception switch 107 which is connected to the transmission unit 103 and switches the input/output signals during transmission and reception, a antenna 104 connected to the transmission/reception switch 107, and a reception unit 108 which is connected to the transmission/reception switch and based on the received wireless signal outputs reception data error information or wireless transmission path information to the transmission path fluctuation period detection unit 101c. A periodic signal generator 109 is also rendered inside the transmission path fluctuation period detection unit 101c.

As shown in FIG. 6A, the wireless communication apparatus according to this embodiment of the invention communicates with wireless terminal 110.

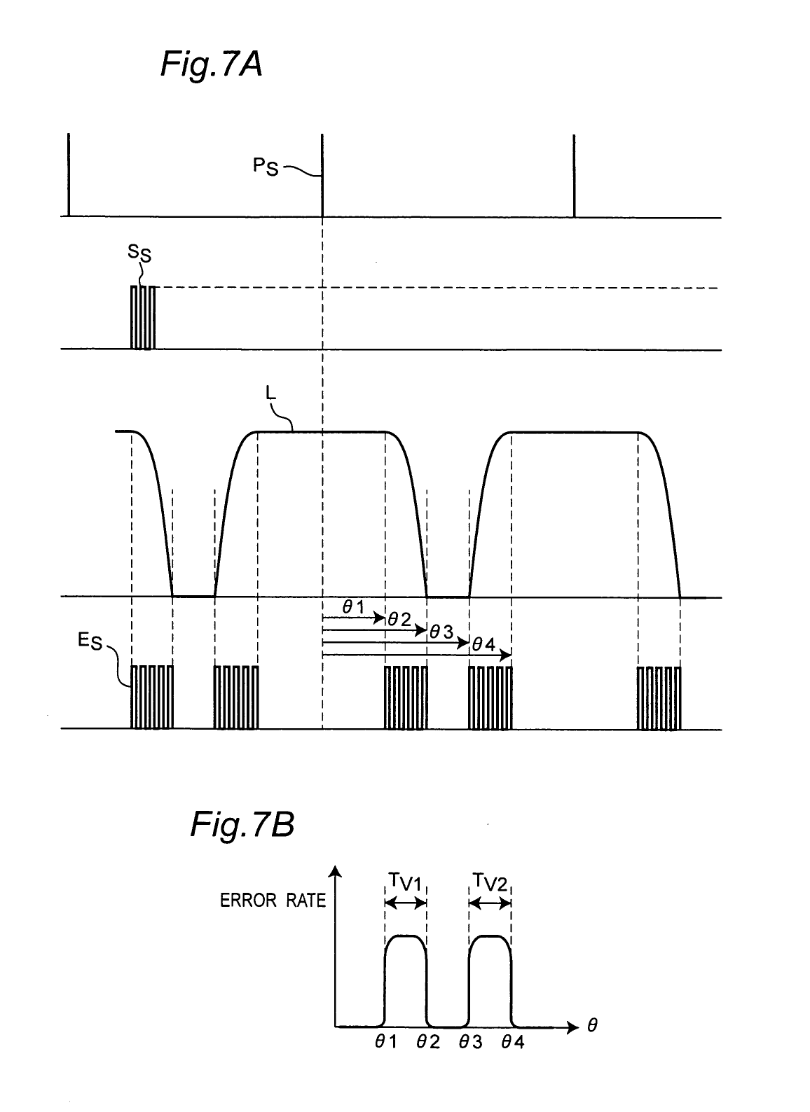

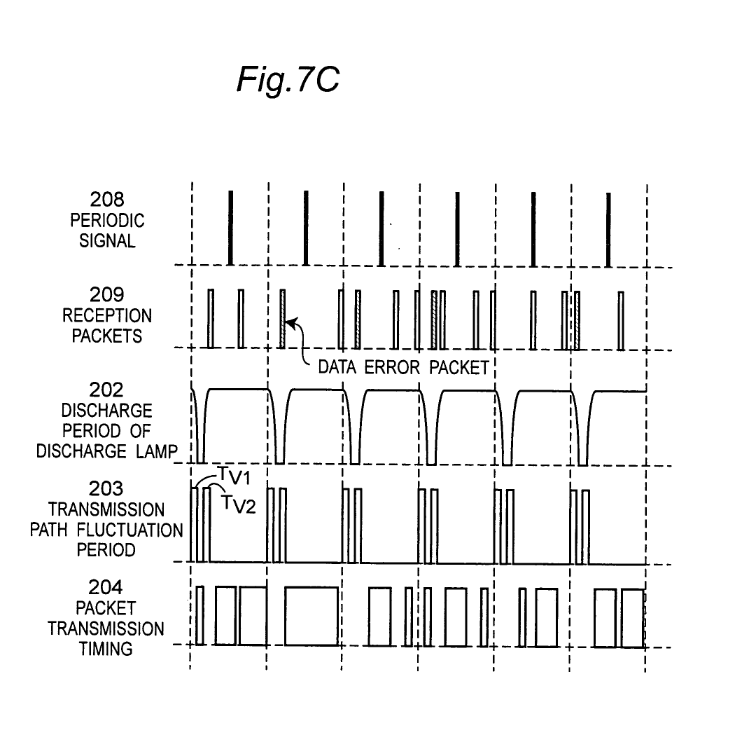

FIG. 7C is a waveform diagram with time on the horizontal axis describing the operation of the wireless communication apparatus according to this third embodiment of the invention.

Like elements and waveforms in FIG. 6A and FIG. 7C and in FIG. 2A and FIG. 2D according to the first embodiment described above are identified by like reference numerals, and further description thereof is omitted here.

The periodic signal 208 shown in FIG. 7C is output by the periodic signal generator 109 in the transmission path fluctuation period detection unit 101c every 1/100 second or 1/120 second. This period is ½ the period of the AC power source. Transmission path fluctuation caused by the discharge lamp is in a substantially constant time-based relationship to this periodic signal, and could therefore gradually shift due to the difference between the period generated by the periodic signal generator 109 and the actual period of the AC power source.

Reference numeral 209 denotes the packets received by the wireless communication apparatus. The received packets include packets containing data errors caused by sudden transmission path fluctuations resulting from discharge lamp fading. The reception unit 108 informs the transmission path fluctuation period detection unit 101c whether data errors occurred in the received packets.

When two wireless communication apparatuses communicate over a wireless transmission path at the same channel frequency, the wireless path from the one wireless communication apparatus (the device having antenna 104 in FIG. 6A) to the other wireless terminal 110 and the wireless transmission path from the other wireless terminal 110 to the one wireless communication apparatus are the same. Fluctuation in the wireless transmission path is therefore equal at any given time. Because the on/off timing of the discharge lamp is known to repeat at a regular period of 1/100 second or 1/120 second, the transmission path fluctuation period of packets transmitted by the one wireless communication apparatus can be detected by detecting the timing at which data errors occur in the received packets.

FIG. 6B is a block diagram of the transmission path fluctuation period detection unit 101c shown in FIG. 6A. Like elements in FIG. 6B and the first embodiment shown in FIG. 2B are identified by like reference numeral, and further detailed description thereof is omitted here.

The transmission path fluctuation period detection unit 101c shown in FIG. 6B has an internal periodic signal generator 310, and this periodic signal generator 310 generates a periodic signal at an interval of 1/100 second or 1/120 second. A data error detector 311 is connected to the output of the reception unit 108 shown in FIG. 6A, and detects data errors in the received signal and outputs an error signal. The error rate distribution detector 312 shown in FIG. 6B detects the error rate distribution based on the periodic signal Ps output from the periodic signal generator 310. The detected error rate distribution is output to counter 303.

The operation whereby the error rate distribution is detected is described next with reference to FIG. 7A.

The periodic signal Ps output from periodic signal generator 310 is not synchronized to the on/off edges of the discharge lamp on signal L, but is substantially synchronous to the on/off period. The transmission unit 103 outputs the transmission signal Ss. The reception unit 108 detects an error when a signal is not correctly received from the wireless terminal 110, and data error detector 311 outputs error signal Es each time an error is detected. The error rate distribution detector 312 determines the phase θ when an error is detected referenced to periodic signal Ps, counts the number of errors in each phase, and acquires the error rate distribution. The error rate distribution is shown in FIG. 7B. From FIG. 7A it will be known that errors are concentrated in the phase intervals from θ1 to θ2 and from θ3 to θ4 references to periodic signal Ps. The error rate distribution detector 312 therefore outputs periodic signals corresponding to the distribution diagram shown in FIG. 7B. The phase interval from θ1 to θ2 corresponds to transmission path fluctuation period Tv1, and the phase interval from θ3 to θ4 corresponds to transmission path fluctuation period Tv2. The counter 303 is reset at periodic signal Ps, begins counting again, and outputs periods Tv1 and Tv2. Based on the count passed from counter 303, the transmission path fluctuation period signal generator 304 generates the transmission path fluctuation period signals.

The error rate distribution detector 312 preferably outputs to the counter 303 after determining the distribution for a specific period of time, such as the distribution for one minute. This prevents mistakenly detecting transmission path fluctuation periods based on data errors caused by factors other than discharge lamps. The counter 303 could also be omitted and the output of the error rate distribution detector 312 input to the periodic signal generator 310 to vary the period of the signals generated by the periodic signal generator 310.

As a result, the transmission path fluctuation period detection unit 101c in a wireless communication apparatus according to this third embodiment of the invention can detect the timing at which sudden transmission path variations occur from the periodic signal Ps output by the periodic signal generator 109 and the error signal Es produced by data error packets from the reception unit 108.

Note that instead of the error signal Es denoting data errors in received packets described above, the reception unit 108 could output an acknowledge signal Ack denoting wireless path information based on the received wireless signals, and the transmission path fluctuation period detection unit 101c could detect the timing at which sudden fluctuations occur in the transmission path during the discharge period of the discharge lamp based on this acknowledge signal Ack.

A wireless communication apparatus according to this embodiment of the invention can thus avoid communication data errors by detecting the timing at which sudden transmission path variations occur based on errors in packets received from another communicating terminal, and stopping data transmission during those periods. A wireless communication apparatus according to this embodiment of the invention also does not require an AC power source metering unit or photoelectric conversion unit, and thus affords a simplified hardware configuration.

Note that the packet length used for data communication could be shortened a specific time from the timing at which the transmission path fluctuation period starts. The communicating wireless terminal normally sends a response signal immediately after transmission from this side ends, but the timing of this response signal can be set to just before the transmission path fluctuation period. This affords more reliable reception of the response signal.

### Embodiment 4

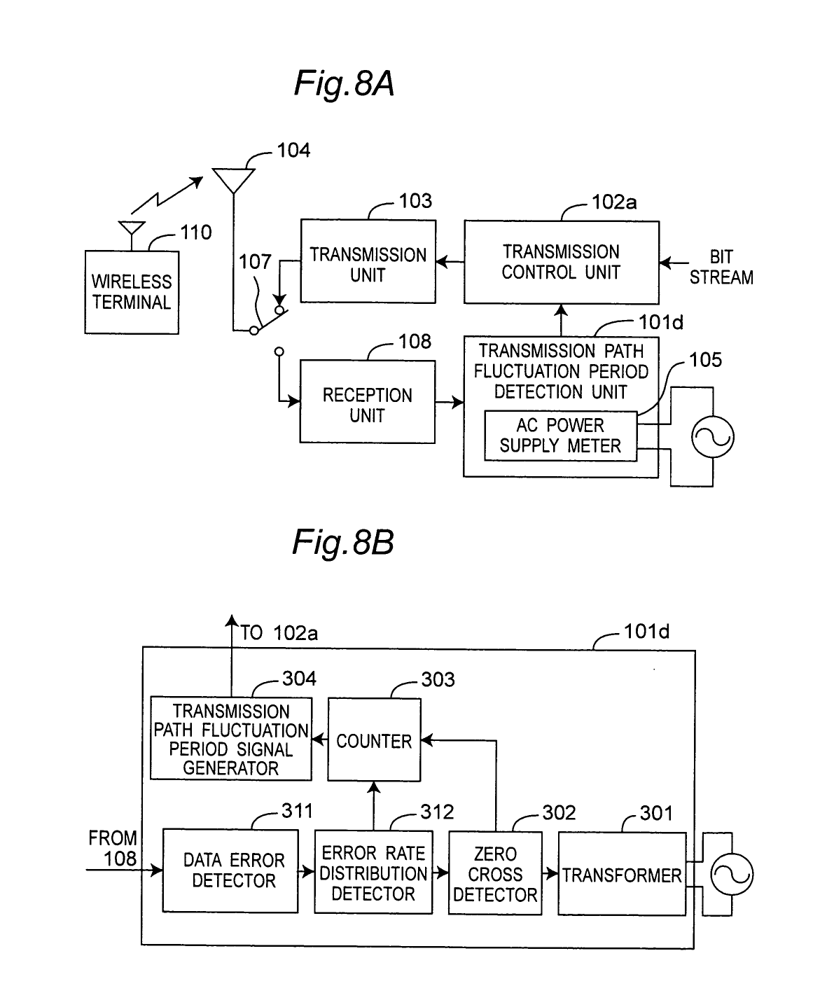

FIG. 8A is a block diagram showing the arrangement of a wireless communication apparatus according to a fourth embodiment of the invention.

As shown in FIG. 8A, a wireless communication apparatus according to this embodiment of the invention has a transmission path fluctuation period detection unit 101d, a transmission control unit 102a to which the transmission path fluctuation period signals Tv1 and Tv2 output by transmission path fluctuation period detection unit 101d are input, a transmission unit 103 to which the transmission signal output by transmission control unit 102a is input, a transmission/reception switch 107 which is connected to the transmission unit 103 and switches the input/output signals during transmission and reception, a antenna 104 connected to the transmission/reception switch 107, and a reception unit 108 which is connected to the transmission/reception switch and based on the received wireless signal outputs reception data error information or wireless transmission path information to the transmission path fluctuation period detection unit 101c. A periodic signal generator 109 is also rendered inside the transmission path fluctuation period detection unit 101c. An AC power supply meter 105 in the transmission path fluctuation period detection unit 101d is connected to an AC power source.

As shown in FIG. 8A, the wireless communication apparatus according to this embodiment of the invention communicates with wireless terminal 110.

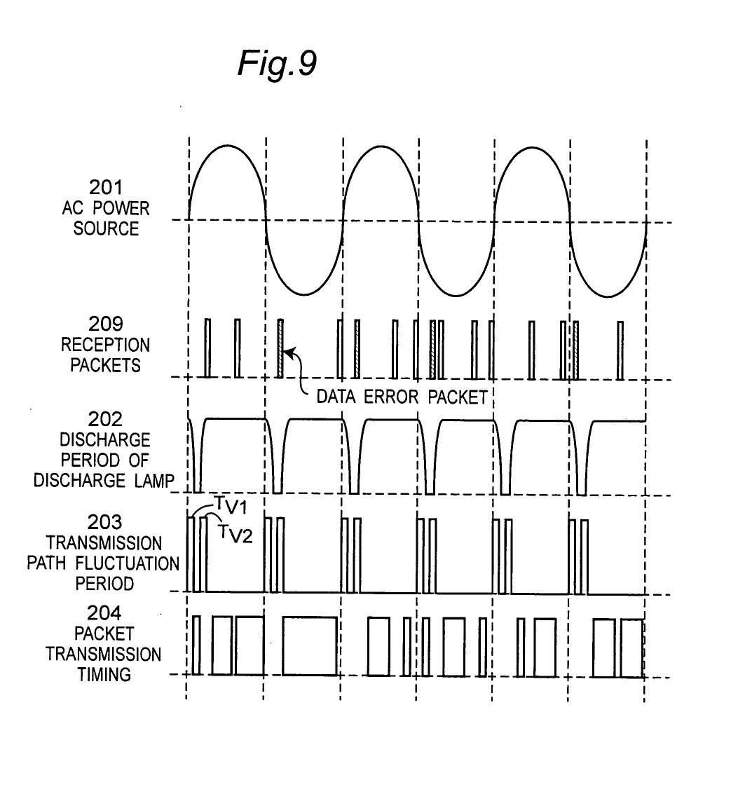

FIG. 9 is a waveform diagram with time on the horizontal axis describing the operation of the wireless communication apparatus according to this fourth embodiment of the invention.

Like elements and waveforms in FIG. 8A and FIG. 9 and in FIG. 2A and FIG. 2D according to the first embodiment described above are identified by like reference numerals, and further description thereof is omitted here.

Waveform 201 in FIG. 9 represents the voltage of the AC power source. The transmission path fluctuation period detection unit 101d detects the precise period of transmission path fluctuation caused by a discharge lamp based on the voltage or current value of the AC power source output by AC power supply meter 105.

Reference numeral 209 denotes the packets received by the reception unit 108 of the wireless communication apparatus. As in the third embodiment, the reception unit 108 informs the transmission path fluctuation period detection unit 101d whether data errors occurred in the received packets. In a wireless communication apparatus according to this fourth embodiment of the invention, the transmission path fluctuation period detection unit 101d detects the timing at which sudden transmission path fluctuations occur based on the voltage or current value of the AC power source output by the AC power supply meter 105 and the timing of the data error packets received from the reception unit 108.

FIG. 8B is a block diagram of the transmission path fluctuation period detection unit 101d shown in FIG. 8A. Like elements in FIG. 8B and the first embodiment shown in FIG. 2B or the third embodiment shown in FIG. 6B are identified by like reference numeral, and further detailed description thereof is omitted here.

In FIG. 8B the transformer 301 is connected to an AC power source and converts the voltage of the AC power source to a signal with a voltage level that can be input to the downstream zero cross detector 302. The zero cross detector 302 detects the zero cross of the supplied voltage from the voltage level signal of the AC power source, and outputs to counter 303. The data error detector 311 is connected to the output of the reception unit 108 shown in FIG. 8A, and outputs a signal when a data error is detected in the reception signal. The error rate distribution detector 312 shown in FIG. 8B outputs a periodic signal determined by the distribution chart shown in FIG. 7B as described in the third embodiment.

More specifically, the error rate distribution detector 312 determines the phase θ in which an error is detected referenced to the zero cross, counts the number of errors in that phase, and acquires the error rate distribution. The error rate distribution detector 312 thus outputs a periodic signal corresponding to the distribution chart shown in FIG. 7B. This fourth embodiment of the invention differs from the foregoing third embodiment, however, in that the reference point for detecting the phase periods is the zero cross instead of periodic signal Ps. The counter 303 resets and starts counting again at the zero cross, and outputs fluctuation periods Tv1 and Tv2. Based on this count, the transmission path fluctuation period signal generator 304 generates the transmission path fluctuation period signal.

Therefore, because the precise period of the AC power source detected by the AC power supply meter is used as the reference for determining the timing at which data error packets occur, the timing and the reference used for detection will not gradually deviate. The transmission path fluctuation period can therefore be easily and accurately determined. Furthermore, because both a measurement based on the AC power source and a measurement based on the reception data are used, the transmission path fluctuation period can be accurately detected even when the relationship between change in the AC power source and the transmission path fluctuation period varies due to individual differences in the discharge lamp fixtures. Operation based on the determined transmission path fluctuation periods Tv1 and Tv2 is the same as described in the first embodiment.

As in the third embodiment above, instead of an error signal denoting data errors in received packets, the reception unit 108 could output an acknowledge signal Ack denoting wireless path information based on the received wireless signals, and the transmission path fluctuation period detection unit 101d could detect the timing at which sudden fluctuations occur in the transmission path during the discharge period of the discharge lamp based on this acknowledge signal Ack.

Furthermore, an AC power supply meter 105 is rendered inside the transmission path fluctuation period detection unit 101 in a wireless communication apparatus according to this embodiment of the invention, but the transmission path fluctuation period can be detected in the same way using a photoelectric conversion unit 106 as described in the second embodiment.

Operation based on the transmission path fluctuation period signals Tv1 and Tv2 is the same as in the first embodiment.

A wireless communication apparatus according to this embodiment of the invention can thus highly accurately detect the transmission path fluctuation periods by using both wireless transmission path information derived from the received packets, and a periodic signal denoting periods of fluctuation in the wireless transmission path output by an AC power supply measurement unit or photoelectric conversion unit. By stopping data transmission timed to the occurrence of sudden fluctuations in the transmission path, a wireless communication apparatus according to this aspect of the invention can avoid communication data errors.

### Embodiment 5

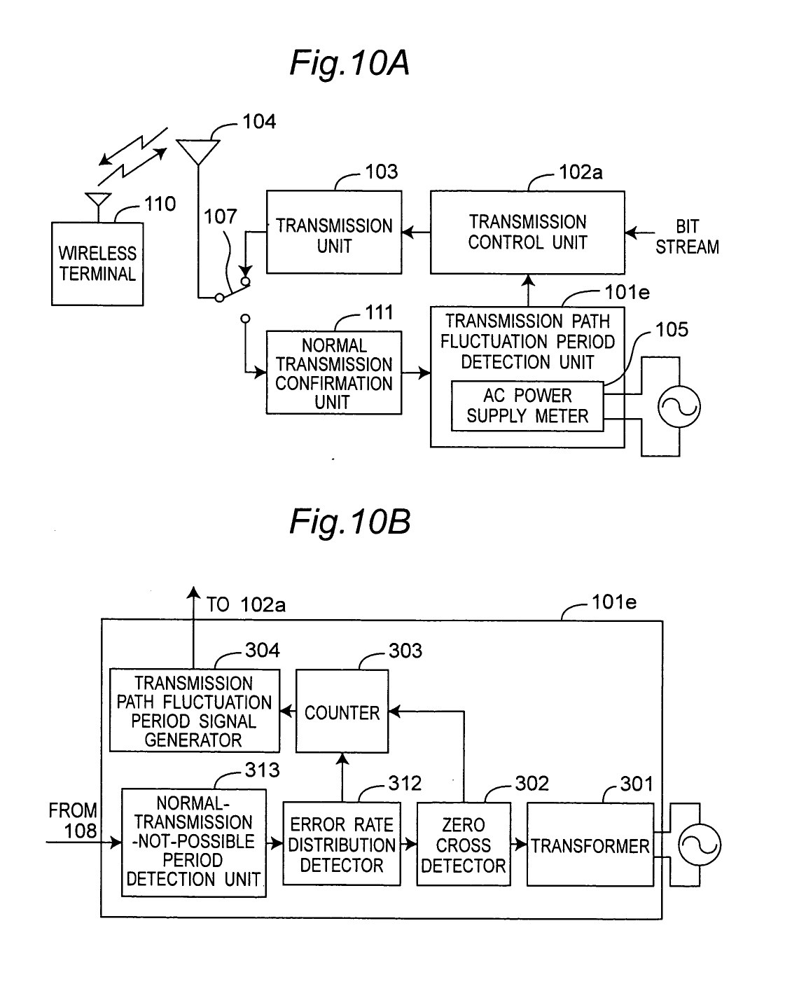

FIG. 10A is a block diagram showing the arrangement of a wireless communication apparatus according to a fifth embodiment of the invention.

As shown in FIG. 10A, a wireless communication apparatus according to this embodiment of the invention has a transmission path fluctuation period detection unit 101e, a transmission control unit 102a to which the transmission path fluctuation period signals Tv1 and Tv2 output by transmission path fluctuation period detection unit 101e are input, a transmission unit 103 to which the transmission signal output by transmission control unit 102a is input, a transmission/reception switch 107 which is connected to the transmission unit 103 and switches the input/output signals during transmission and reception, an antenna 104 connected to the transmission/reception switch 107, and a normal transmission confirmation unit 111 which is connected to the transmission/reception switch and outputs a signal denoting if the packets sent to the transmission path fluctuation period detection unit were transferred successfully. A periodic signal generator 109 is also rendered inside the transmission path fluctuation period detection unit 101e.

As shown in FIG. 10A, the wireless communication apparatus according to this embodiment of the invention communicates with wireless terminal 110. If a communication data error is not detected when a packet is received, the destination wireless terminal 110 returns a wireless packet (acknowledge signal Ack) indicating that the. packet was successfully received to this wireless communication apparatus. If an error is detected in the packet received by the wireless terminal 110 or if the wireless signal was not received, the wireless terminal 110 sends a packet (error signal) indicating that the packet was not successfully received to this wireless communication apparatus or sends no signal at all. The normal transmission confirmation unit 111 determines whether transmission was successful based on the wireless packet received from the other wireless terminal 110.

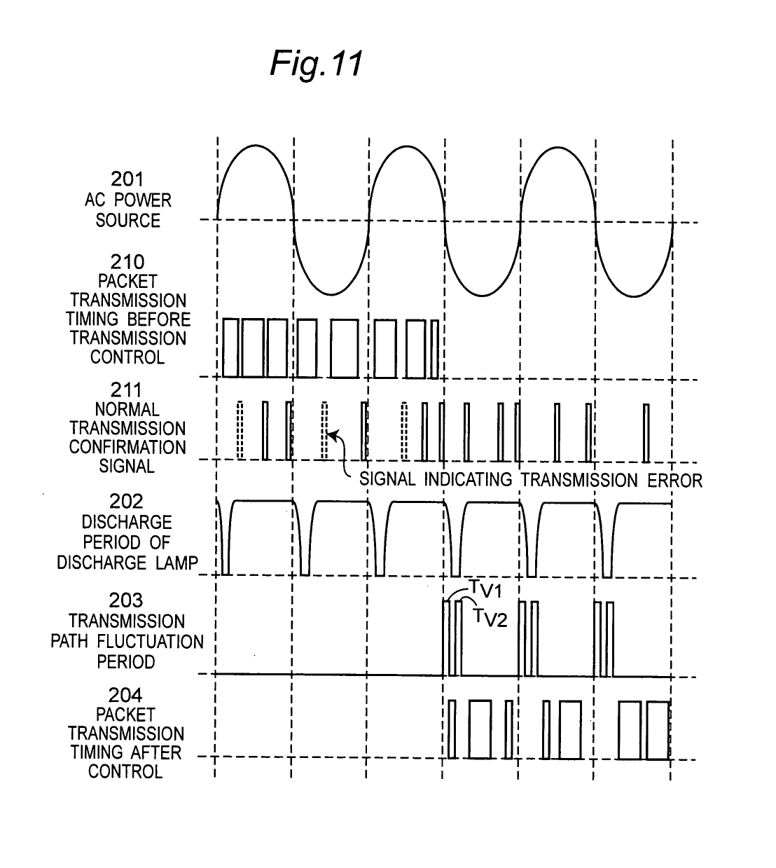

FIG. 11 is a waveform diagram with time on the horizontal axis describing the operation of the wireless communication apparatus according to this fifth embodiment of the invention.

Like elements and waveforms in FIG. 10A and FIG. 11 and in FIG. 2A and FIG. 2D according to the first embodiment described above are identified by like reference numerals, and further description thereof is omitted here.

Waveform 201 in FIG. 11 represents the voltage of the AC power source. The transmission path fluctuation period detection unit 101e detects the precise period of transmission path fluctuation caused by a discharge lamp based on the voltage or current value of the AC power source output by AC power supply meter 105.

Waveform 210 denotes the transmission timing of packets that are output before the wireless communication apparatus of this embodiment controls transmission based on the transmission path fluctuation period. The destination wireless terminal 110 normally returns a wireless packet (acknowledge signal Ack) immediately after these packets are received indicating that the packets were received correctly. However, if a data error occurs due to sudden transmission path fluctuation caused by discharge lamp fading, the wireless terminal 110 sends a wireless packet indicating that reception failed or sends no packet at all. The normal transmission confirmation unit 111 receives these packets (acknowledge signal Ack) output by the wireless terminal 110, and outputs the result to the transmission path fluctuation period detection unit 101e. Waveform 211 denotes the signal output by the normal transmission confirmation unit 111.

FIG. 10B is a block diagram of the transmission path fluctuation period detection unit 101e shown in FIG. 10A. Like elements in FIG. 10B and the first embodiment shown in FIG. 2B or the third embodiment shown in FIG. 6B are identified by like reference numeral, and further detailed description thereof is omitted here.

In FIG. 10B the transformer 301 is connected to an AC power source and converts the voltage of the AC power source to a signal with a voltage level that can be input to the downstream zero cross detector 302. The zero cross detector 302 detects the zero cross of the supplied voltage from the voltage level signal of the AC power source, and outputs to counter 303. A normal-transmission-not-possible period detection unit 313 is connected to the output of the normal transmission confirmation unit 111 shown in FIG. 10A, monitors transmission signals output from the 103a, and detects normal reception of the reception signal (acknowledge signal Ack). The normal-transmission-not-possible period detection unit 313 determines that transmitted signals for which an acknowledge signal Ack is received were received without errors, but determines that errors occurred in the transmitted signals for which an acknowledge signal Ack is not received and therefore outputs an error signal.

As described in the third embodiment, the error rate distribution detector 312 shown in FIG. 10B outputs a periodic signal based on the distribution diagram shown in FIG. 7B. More specifically, the error rate distribution detector 312 determines the phase θ in which an error is detected referenced to the zero cross, counts the number of errors in that phase, and acquires the error rate distribution. The error rate distribution detector 312 thus outputs a periodic signal corresponding to the distribution chart shown in FIG. 7B. The counter 303 resets and starts counting again at the zero cross, and outputs fluctuation periods Tv1 and Tv2. Based on this count, the transmission path fluctuation period signal generator 304 generates the transmission path fluctuation period signal.

Waveform 212 in FIG. 11 shows the packet transmission timing after transmission control based on the transmission path fluctuation period is applied.

A wireless communication apparatus according to this embodiment of the invention can thus detect the fluctuation cycle of the wireless transmission path and the transmission path fluctuation period from response packets received from the destination terminal in response to wireless packets sent by the wireless communication apparatus of this embodiment, and by stopping data transmission when sudden transmission path fluctuation occurs the wireless communication apparatus of this embodiment can avoid communication data errors.

### Embodiment 6

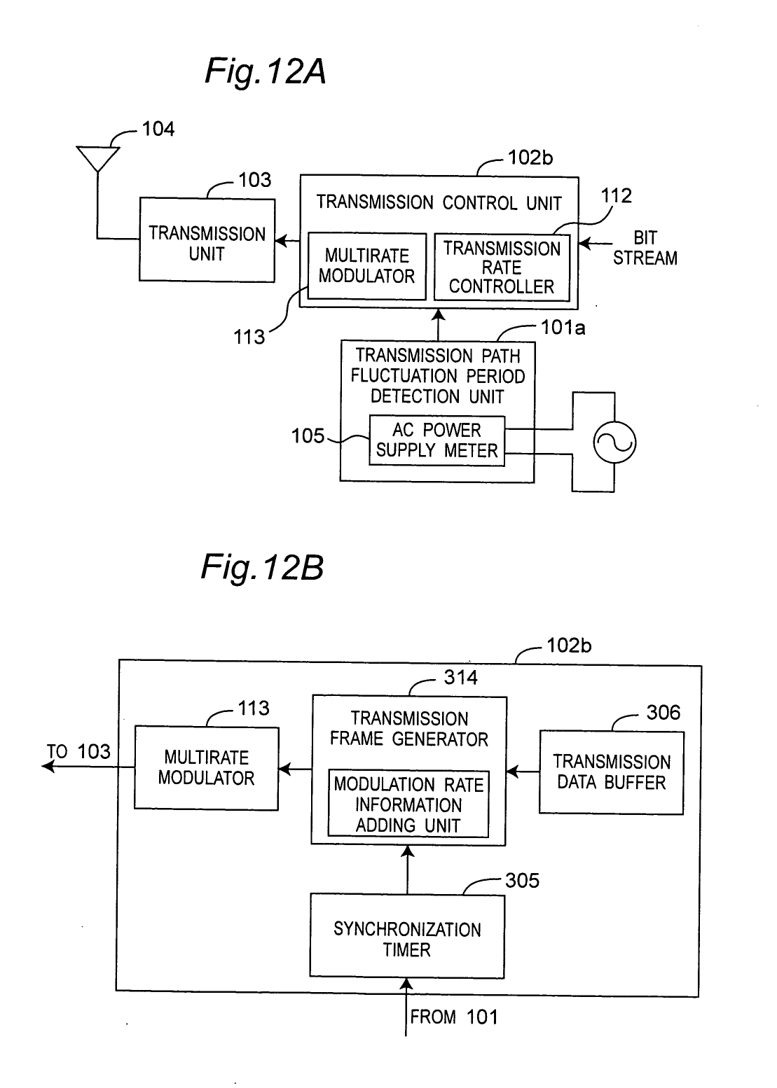

FIG. 12A is a block diagram showing the arrangement of a wireless communication apparatus according to a sixth embodiment of the invention.

As shown in FIG. 12A, a wireless communication apparatus according to this embodiment of the invention has a transmission path fluctuation period detection unit 101a, a transmission control unit 102b to which the transmission path fluctuation period signals Tv1 and Tv2 output by transmission path fluctuation period detection unit 101a are input, a transmission unit 103 to which the transmission signal output by transmission control unit 102b is input, and an antenna 104 connected to the transmission unit 103. An AC power supply meter 105 is also rendered inside the transmission path fluctuation period detection unit 101a and connected to the AC power source.

In addition, a transmission rate controller 112 for setting the modulation rate of the transmission signal, and a multirate modulator 113 that varies the symbol rate, modulation level, or bit rate of the error correction code, for example, to modulate the wireless signal, and inserts this modulation rate information in the wireless packets, are also provided.

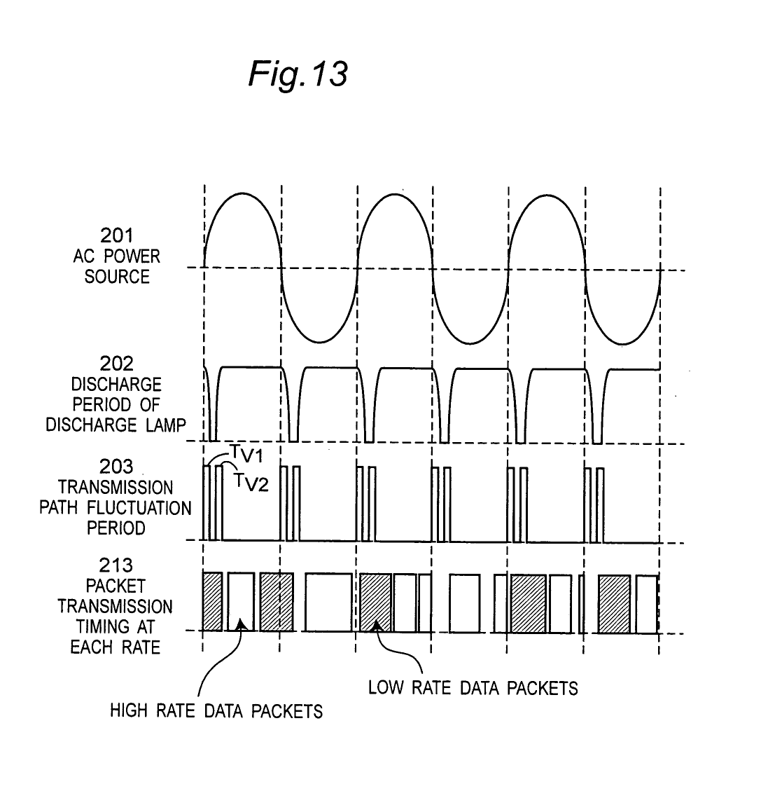

FIG. 13 is a waveform diagram with time on the horizontal axis describing the operation of the wireless communication apparatus according to this sixth embodiment of the invention.

Like elements and waveforms in FIG. 12A and FIG. 13 and in FIG. 2A and FIG. 2D according to the first embodiment described above are identified by like reference numerals, and further description thereof is omitted here.

The operation whereby this embodiment of the invention detects the transmission path fluctuation period is the same as described above in the first embodiment.

Based on the transmission path fluctuation period signals Tv1 and Tv2 output from the transmission path fluctuation period detection unit 101a, transmission control unit 102b decreases the modulation rate for wireless packets transmitted in signals Tv1, Tv2 indicating a period of increasing transmission path fluctuation, and increases the modulation rate for wireless packets transmitted in the period outside the Tv1, Tv2 signal period. The multirate modulator 113 generates and outputs wireless packets at the modulation rate determined by the transmission signals from the transmission rate controller 112.

FIG. 12B is a block diagram of the transmission control unit 102 shown in FIG. 12A. Like elements in FIG. 12B and the first embodiment shown in FIG. 2C are identified by like reference numeral, and further detailed description thereof is omitted here.

Referring to FIG. 12B, synchronization timer 305 receives the transmission path fluctuation period signals Tv1, Tv2 from the transmission path fluctuation period detection unit 101 shown in FIG. 12A and outputs how much time there is when there is no transmission path fluctuation until transmission path fluctuation occurs again.

When data is received from the transmission data buffer 306, the transmission frame generator 314 determines based on the signal from the synchronization timer 305 if the packet transmitted next will be transmitted during a transmission path fluctuation period. If the wireless packet transmission period is coincident to the transmission path fluctuation periods Tv1 and Tv2, information indicating that low bit rate modulation was applied is added to the header of the transmitted frame. Conversely, if the wireless packet transmission period does not overlap transmission path fluctuation period Tv1 or Tv2, information indicating high bit rate modulation is added to the header of the transmitted frame. The multirate modulator 113 applies low bit rate modulation (such as QPSK modulation) to transmission frames having information indicating low bit rate modulation in the header, and applies high bit rate modulation (such as 64QAM) to transmission frames having information indicating high bit rate modulation in the header.

Waveform 213 in FIG. 13 shows the bit rate and transmission timing of wireless packets transmitted by a wireless communication apparatus according to this embodiment of the invention. When the output wireless packets are transmitted at least in part during the transmission path fluctuation periods Tv1 and Tv2, the wireless communication apparatus according to this embodiment of the invention transmits wireless packets modulated at a low rate, but when the wireless packet transmission does not overlap transmission path fluctuation periods Tv1 and Tv2, the wireless communication apparatus transmits wireless packets modulated at a high rate. By thus decreasing the modulation rate of the wireless packets at least during the transmission path fluctuation periods Tv1 and Tv2, a wireless communication apparatus according to this embodiment of the invention can transmit wireless packets with greater fading resistance. Communication data errors can thus be avoided.

In the sixth embodiment of the invention the transmission control unit 102b selects a restricted transmission mode for transmitting data packets at a low rate when the packet transmission period will overlap any part of transmission path fluctuation periods Tv1 and Tv2, and selects a normal transmission mode in which data packets are transmitted at a high rate when the packet transmission period does not overlap any part of the transmission path fluctuation periods Tv1 and Tv2.

It should be noted that the optimum modulation rate for the transmission path fluctuation period can be selected in a wireless communication apparatus according to this embodiment of the invention by additionally providing a normal transmission confirmation unit 111 to input a normal transmission confirmation signal to the transmission rate controller 112 as described in the fifth embodiment. This aspect of the invention enables using the highest modulation rate possible.

### Embodiment 7

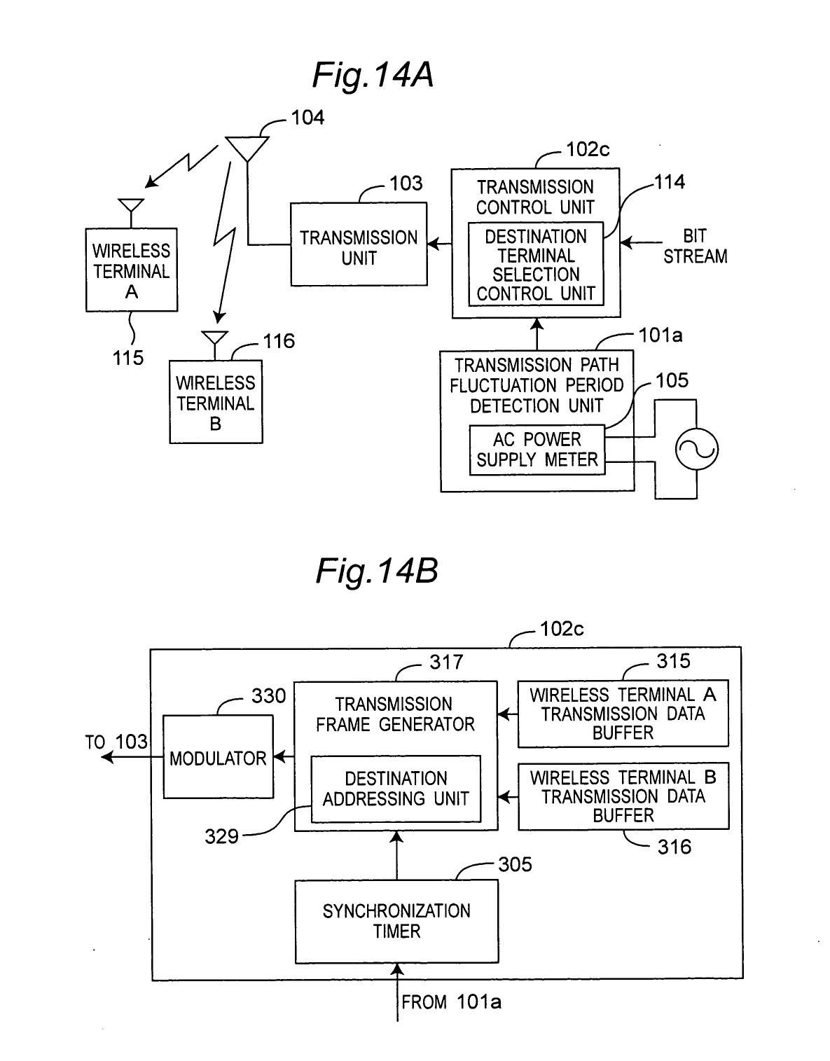

FIG. 14A is a block diagram showing the arrangement of a wireless communication apparatus according to a seventh embodiment of the invention.

As shown in FIG. 14A, a wireless communication apparatus according to this embodiment of the invention has a transmission path fluctuation period detection unit 101a, a transmission control unit 102c to which the transmission path fluctuation period signals Tv1 and Tv2 output by transmission path fluctuation period detection unit 101a are input, a transmission unit 103 to which the transmission signal output by transmission control unit 102c is input, and an antenna 104 connected to the transmission unit 103. An AC power supply meter 105 is also rendered inside the transmission path fluctuation period detection unit 101a and connected to the AC power source. In addition, a destination terminal selection control unit 114 for selecting the terminal to receive the transmitted signals is also rendered in the transmission control unit 102c.

As shown in FIG. 14A, a wireless communication apparatus according to this embodiment of the invention communicates with two wireless terminals, wireless terminal A 115 and wireless terminal B 116. It is assumed below that the radio communication path between the wireless communication apparatus of this invention and wireless terminal A 115 is subject to large transmission path fluctuations caused by discharge lamp fading while transmission path fluctuation on the wireless path between the wireless communication apparatus of this invention and wireless terminal B 116 is small. More specifically, it is known in advance that there is a discharge lamp between the wireless communication apparatus according to this embodiment of the invention and wireless terminal A 115, but a discharge lamp is not present between the wireless communication apparatus according to this embodiment of the invention and wireless terminal B 116.

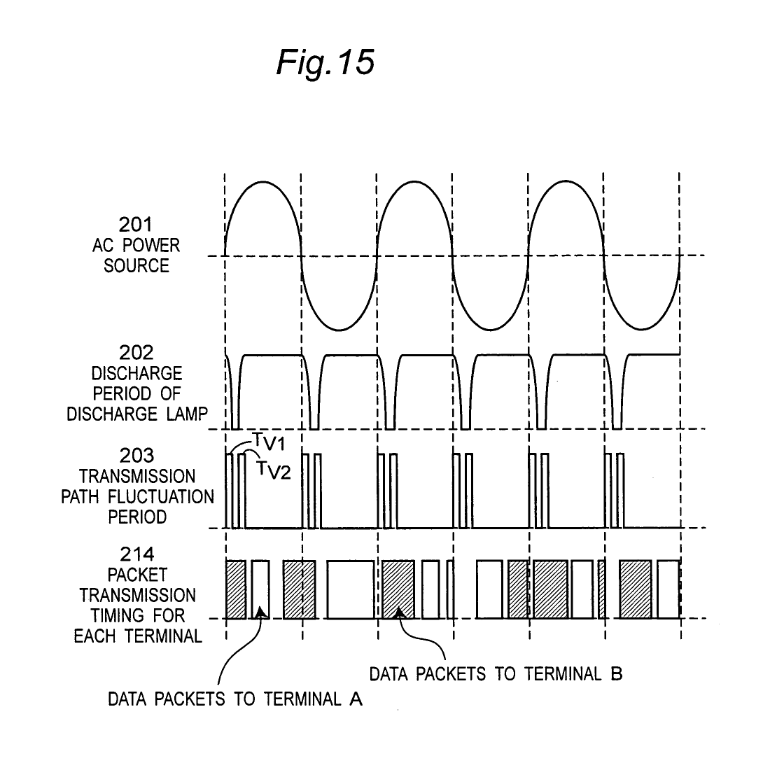

FIG. 15 is a waveform diagram with time on the horizontal axis describing the operation of the wireless communication apparatus according to this seventh embodiment of the invention.

Like elements and waveforms in FIG. 14A and FIG. 15 and in FIG. 2A and FIG. 2D according to the first embodiment described above are identified by like reference numerals, and further description thereof is omitted here.

The operation whereby this embodiment of the invention detects the transmission path fluctuation period is the same as described above in the first embodiment.

Based on the signals Tv1 and Tv2 denoting the result of transmission path fluctuation period detection output from the transmission path fluctuation period detection unit 101a, the destination terminal selection control unit 114 in the transmission control unit 102c selects communication with wireless terminal B 116 where a discharge lamp is not present in the transmission path if communication occurs during transmission path fluctuation periods Tv1 and Tv2, but if transmission is during a period not including transmission path fluctuation periods Tv1 and Tv2, the destination terminal selection control unit 114 selects communication with wireless terminal A 115 where a discharge lamp is present in the transmission path or communication with wireless terminal B 116 where a discharge lamp is not present in the transmission path. The transmission unit 103 then transmits the wireless packets received from the transmission control unit 102.

FIG. 14B is a block diagram of the transmission control unit 102 shown in FIG. 14A. Like elements in FIG. 14B and the first embodiment shown in FIG. 2C are identified by like reference numeral, and further detailed description thereof is omitted here.

Referring to FIG. 14B, synchronization timer 305 receives the transmission path fluctuation period signals Tv1, Tv2 from the transmission path fluctuation period detection unit 101a shown in FIG. 14A and outputs how much time there is when there is no transmission path fluctuation until transmission path fluctuation occurs again.

The transmission control unit 102c in a wireless communication apparatus according to this embodiment of the invention has two transmission data buffers, transmission data buffer 315 for communicating with wireless terminal A, and transmission data buffer 316 for communicating with wireless terminal B.

The transmission frame generator 317 has a destination addressing unit 329 and controls adding the destination address based on signals from the synchronization timer 305. If any part of the wireless packet transmission period overlaps transmission path fluctuation periods Tv1 and Tv2, transmission frame generator 317 reads data from wireless terminal B transmission data buffer 116 and adds the address for wireless terminal B to the header of the transmission frame. However, if the wireless packet transmission period does not overlap any part of transmission path fluctuation periods Tv1 and Tv2, transmission frame generator 317 reads data from wireless terminal A transmission data buffer 315 or wireless terminal B transmission data buffer 316, and adds the address of the corresponding destination terminal to the transmission frame header. The address transmission frame is then sent to the modulator 330 for modulation, and then sent to the transmission unit 103.

In FIG. 15 waveform 214 shows the transmission timing and the wireless packets transmitted by the wireless communication apparatus of the present embodiment for reception by the selected terminal.

The wireless communication apparatus according to this embodiment of the invention can thus avoid the effects of discharge lamp fading because the destination terminal for receiving the wireless packets is selected at least during transmission path fluctuation periods Tv1 and Tv2. Communication data errors can thus be avoided.

The transmission control unit 102c in this seventh embodiment of the invention thus selects a restricted transmission mode in which data packets are transmitted to a specific predetermined terminal if the packet transmission period overlaps any part of transmission path fluctuation periods Tv1 and Tv2, and selects a normal transmission mode in which data packets can be transmitted to any terminal without limitation if the packet transmission period does not overlap a transmission path fluctuation period.

### Embodiment 8

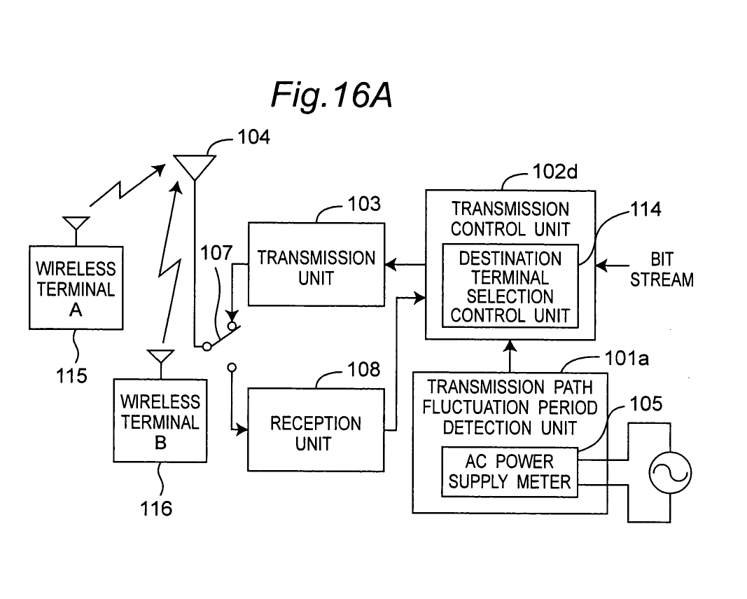

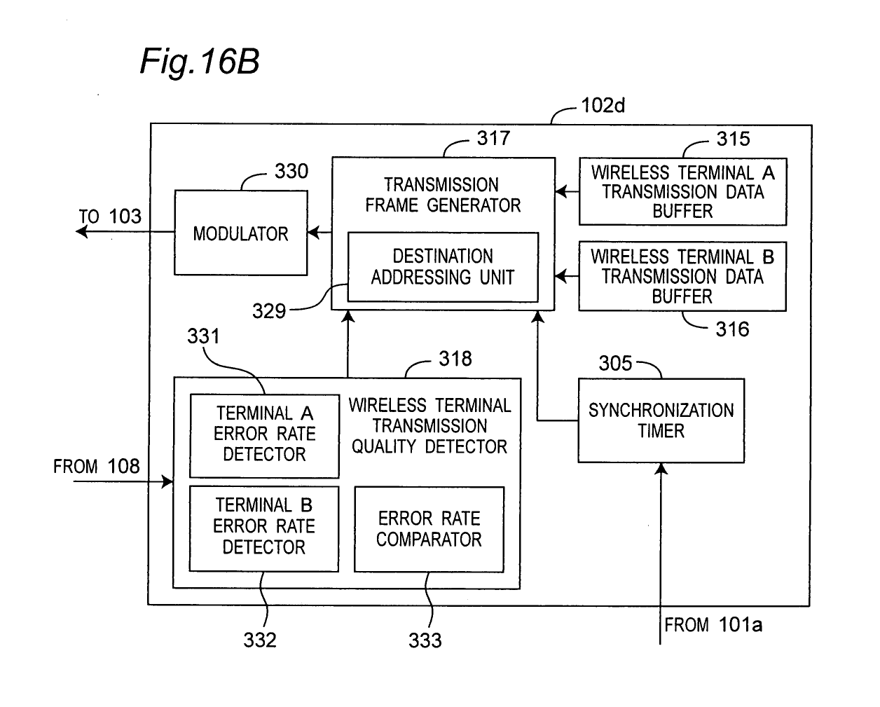

FIG. 16A is a block diagram showing the arrangement of a wireless communication apparatus according to an eighth embodiment of the invention.

As shown in FIG. 16A, a wireless communication apparatus according to this embodiment of the invention has a transmission path fluctuation period detection unit 101a, a transmission control unit 102d to which the transmission path fluctuation period signals Tv1 and Tv2 output by transmission path fluctuation period detection unit 101a are input, a transmission unit 103 to which the transmission signal output by transmission control unit 102d is input, a transmission/reception switch 107 which is connected to the transmission unit 103 and switches the input/output signals during transmission and reception, an antenna 104 connected to the transmission/reception switch 107, and a reception unit 108 that is connected to the transmission/reception switch and analyzes reception data errors for each wireless terminal based on the received wireless signals.

An AC power supply meter 105 is also rendered inside the transmission path fluctuation period detection unit 101a and connected to the AC power source. In addition, a destination terminal selection control unit 114 is also rendered in the transmission control unit 102d for selecting the terminal to receive the transmitted signals as a condition of the transmitted signals.

As shown in FIG. 16A, a wireless communication apparatus according to this embodiment of the invention communicates with two wireless terminals, wireless terminal A 115 and wireless terminal B 116.

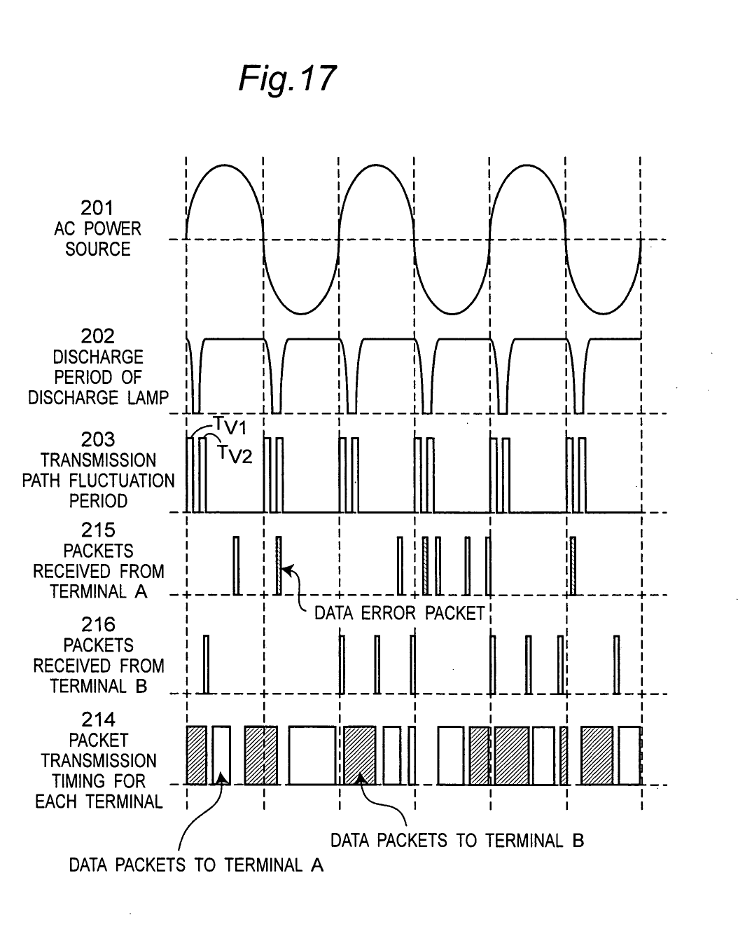

FIG. 17 is a waveform diagram with time on the horizontal axis describing the operation of the wireless communication apparatus according to this seventh embodiment of the invention.

Like elements and waveforms in FIG. 16A and FIG. 17 and in FIG. 2A and FIG. 2D according to the first embodiment described above are identified by like reference numerals, and further description thereof is omitted here.

The operation whereby this embodiment of the invention detects the transmission path fluctuation period is the same as described above in the first embodiment.

In FIG. 17 waveform 215 represents packets received by the wireless communication apparatus from wireless terminal A 115, and waveform 216 represents packets received by the wireless communication apparatus from wireless terminal B 116. Data errors occur during the transmission path fluctuation period 203 detected by transmission path fluctuation period detection unit 101 in the packets received from wireless terminal A. Errors do not occur in the packets received from wireless terminal B, however. The reception unit 108 outputs data error information for the packets received from each wireless terminal to the transmission control unit 102d.

FIG. 16B is a block diagram of the transmission control unit 102d shown in FIG. 16A. Like elements in FIG. 16B and the first embodiment shown in FIG. 2C and the seventh embodiment shown in FIG. 14B are identified by like reference numeral, and further detailed description thereof is omitted here.

Referring to FIG. 16B, synchronization timer 305 receives the transmission path fluctuation period signals Tv1, Tv2 from the transmission path fluctuation period detection unit 101a shown in FIG. 16A and outputs how much time there is when there is no transmission path fluctuation until transmission path fluctuation occurs again.

Wireless terminal transmission quality detector 318 has a terminal A error rate detector 331, terminal B error rate detector 332, and error rate comparator 333. The signal denoting the reception status that is output from reception unit 108 contains an error signal, and this error signal enables determining whether there are errors in the packet signals from any terminal. The terminal A error rate detector 331 receives an error signal from terminal A and determines the error rate. The terminal B error rate detector 332 receives an error signal from terminal B and determines the error rate. This error rate could be an error rate distribution as shown in FIG. 7B, or simply a count indicating the number of error signals occurring in a specific unit of time. The error rate comparator 333 compares the error rates from the two error rate detectors 331, 332, determines that transmission path fluctuation is high on the communication path with the terminal having the higher error rate, and determines that transmission path fluctuation is low on the path with the terminal having the lower error rate. This embodiment of the invention is described below assuming that there are more errors in the wireless packets transmitted from wireless terminal A.

Based on signals from the synchronization timer 305, the transmission frame generator 317 determines if the next packets to be transmitted will be transmitted during a transmission path fluctuation period.

If the wireless packet transmission period overlaps any part of transmission path fluctuation periods Tv1 and Tv2, the transmission frame generator 317 selects the terminal with the lower error rate, that is, terminal B in this example, based on information from the wireless terminal transmission quality detector 318. The transmission frame generator 317 therefore reads data from wireless terminal B transmission data buffer 316, destination addressing unit 329 adds the address of wireless terminal B to the frame header, and outputs the resulting frame to the modulator 330.

On the other hand, if the wireless packet transmission period does not overlap any part of transmission path fluctuation periods Tv1 and Tv2, the transmission frame generator 317 reads data from either wireless terminal A transmission data buffer 315 or wireless terminal B transmission data buffer 316, adds the address of the corresponding terminal to the frame header, and passes the frame to the modulator 330.

Referring to FIG. 17, waveform 214 shows the transmission timing and the wireless packets transmitted by the wireless communication apparatus of the present embodiment for reception by the selected terminal.

The wireless communication apparatus according to this embodiment of the invention can thus avoid the effects of discharge lamp fading because the destination terminal for receiving the wireless packets is selected at least during transmission path fluctuation periods Tv1 and Tv2. Communication data errors can thus be avoided.

The transmission control unit 102d in this eighth embodiment of the invention thus selects a restricted transmission mode in which data packets are transmitted to a specific terminal determined from the cumulative error rate if the packet transmission period overlaps any part of transmission path fluctuation periods Tv1 and Tv2, and selects a normal transmission mode in which data packets can be transmitted to any terminal without limitation if the packet transmission period does not overlap a transmission path fluctuation period.

### Embodiment 9

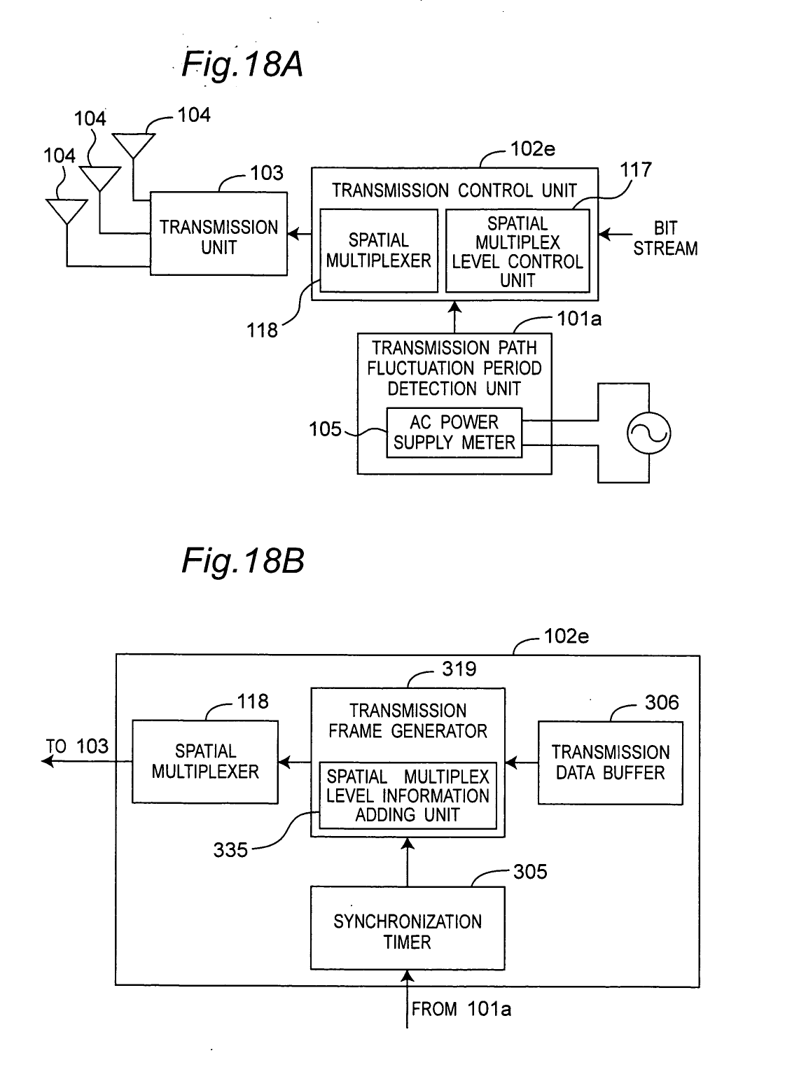

FIG. 18A is a block diagram showing the arrangement of a wireless communication apparatus according to a ninth embodiment of the invention.

As shown in FIG. 18A, a wireless communication apparatus according to this embodiment of the invention has a transmission path fluctuation period detection unit 101a, a transmission control unit 102e to which the transmission path fluctuation period signals Tv1 and Tv2 output by transmission path fluctuation period detection unit 101a are input, a transmission unit 103 to which the transmission signal output by transmission control unit 102e is input, and an antenna 104 connected to the transmission unit 103. An AC power supply meter 105 is also rendered inside the transmission path fluctuation period detection unit 101a and connected to the AC power source. In addition, a spatial multiplex level control unit 117 for controlling the spatial multiplex levels of the transmitted wireless signal, and a spatial multiplexer 118 that can change the number of spatial mutiplexing levels, are rendered inside the transmission control unit 102e.

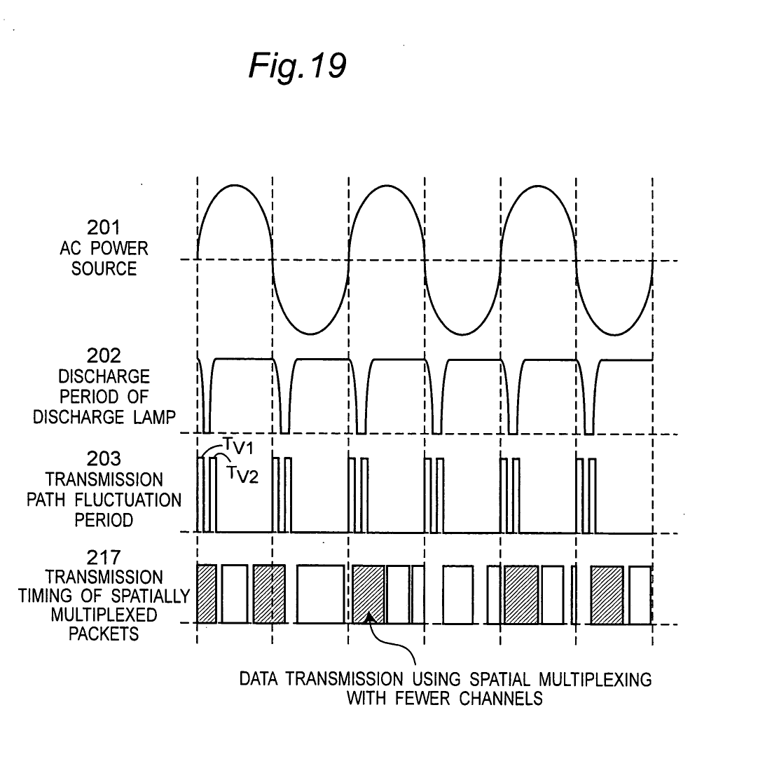

FIG. 19 is a waveform diagram with time on the horizontal axis describing the operation of the wireless communication apparatus according to this ninth embodiment of the invention.

Like elements and waveforms in FIG. 18A and FIG. 19 and in FIG. 2A and FIG. 2D according to the first embodiment described above are identified by like reference numerals, and further description thereof is omitted here.

The operation whereby this embodiment of the invention detects the transmission path fluctuation period is the same as described above in the first embodiment.

MIMO wireless communication and other wireless communication methods using spatial multiplexing are effective as a means of increasing the transfer rate, but are sensitive to fading and thus suffer from significant degradation of communication quality when there are transmission path disturbances.

Based on signals denoting the result of transmission path fluctuation period detection output by the transmission path fluctuation period detection unit 101a, the spatial multiplex level control unit 117 of the transmission control unit 102e either decreases the spatial multiplexing levels or blocks multiplexing of wireless packets timed for transmission when transmission path interference will be high. Based on the spatial multiplexing level set by the spatial multiplex level control unit 117, the spatial multiplexer 118 then generates and outputs the wireless packets.

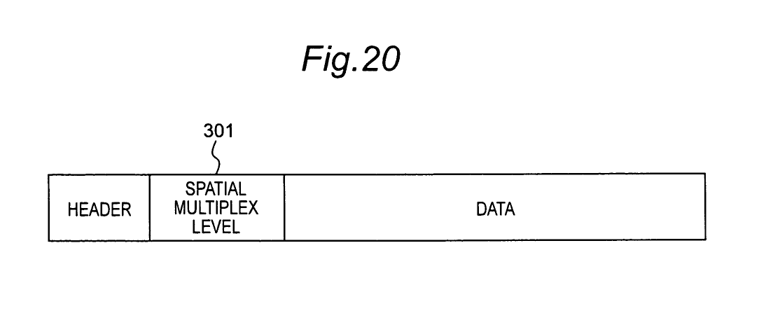

FIG. 20 shows a wireless packet transmitted by a wireless communication apparatus according to this embodiment of the invention. Each wireless packet is composed of a header used for reception gain control or synchronization detection, a spatial multiplexing level block 301, and a data block. The spatial multiplexing level block 301 is added by the spatial multiplexer 118 so that the spatial multiplexing level information for the transferred wireless packets is available to the wireless terminal.

FIG. 18B is a block diagram of the transmission control unit 102e shown in FIG. 18A. Like elements in FIG. 18B and the first embodiment shown in FIG. 2C are identified by like reference numeral, and further detailed description thereof is omitted here.

Referring to FIG. 18B, synchronization timer 305 receives the transmission path fluctuation period signals Tv1, Tv2 from the transmission path fluctuation period detection unit 101a shown in FIG. 12A and outputs how much time there is when there is no transmission path fluctuation until transmission path fluctuation occurs again.

When data is received from transmission data buffer 306, transmission frame generator 319 determines if the next packets to be transmitted will be transmitted during a transmission path fluctuation period based on signals from the synchronization timer synchronization timer 305.

If the wireless packet transmission period overlaps any part of transmission path fluctuation periods Tv1 and Tv2, the transmission frame generator 319 adds information indicating modulation using few spatial multiplexing levels to the transmission frame header. However, if the wireless packet transmission period does not overlap any part of transmission path fluctuation periods Tv1 and Tv2, the transmission frame generator 319 adds information indicating modulation using the highest possible spatial multiplexing level to the transmission frame header.

Referring to FIG. 19, waveform 217 shows the transmission timing and the number of channels used for spatial multiplexing of wireless packets transmitted by the wireless communication apparatus according to this embodiment of the invention. When wireless packets are not transmitted during transmission path fluctuation periods Tv1 and Tv2 in a wireless communication apparatus according to this embodiment of the invention, the wireless packets are generated using spatial multiplexing for transmission over N (where N is a positive integer) antennas. If the transmitted wireless packets overlap transmission path fluctuation periods Tv1 and Tv2, the wireless packets are generated using spatial multiplexing for transmission over M (where M is a positive integer) antennas. Note that N>M, and M>=1.

A wireless communication apparatus according to this embodiment of the invention thus improves fading resistance by reducing the number of spatial multiplexing levels for packets transmitted at a timing subject to sudden transmission path disruptions. Communication data errors can thus be avoided.

The transmission control unit 102e in this ninth embodiment of the invention thus selects a restricted transmission mode in which data packets are transmitted without multiplexing or with multiplexing using a low spatial multiplex level if the packet transmission period overlaps any part of transmission path fluctuation periods Tv1 and Tv2, and selects a normal transmission mode in which data packets can be transmitted using the highest possible spatial multiplexing level without limitation if the packet transmission period does not overlap a transmission path fluctuation period.

### Embodiment 10

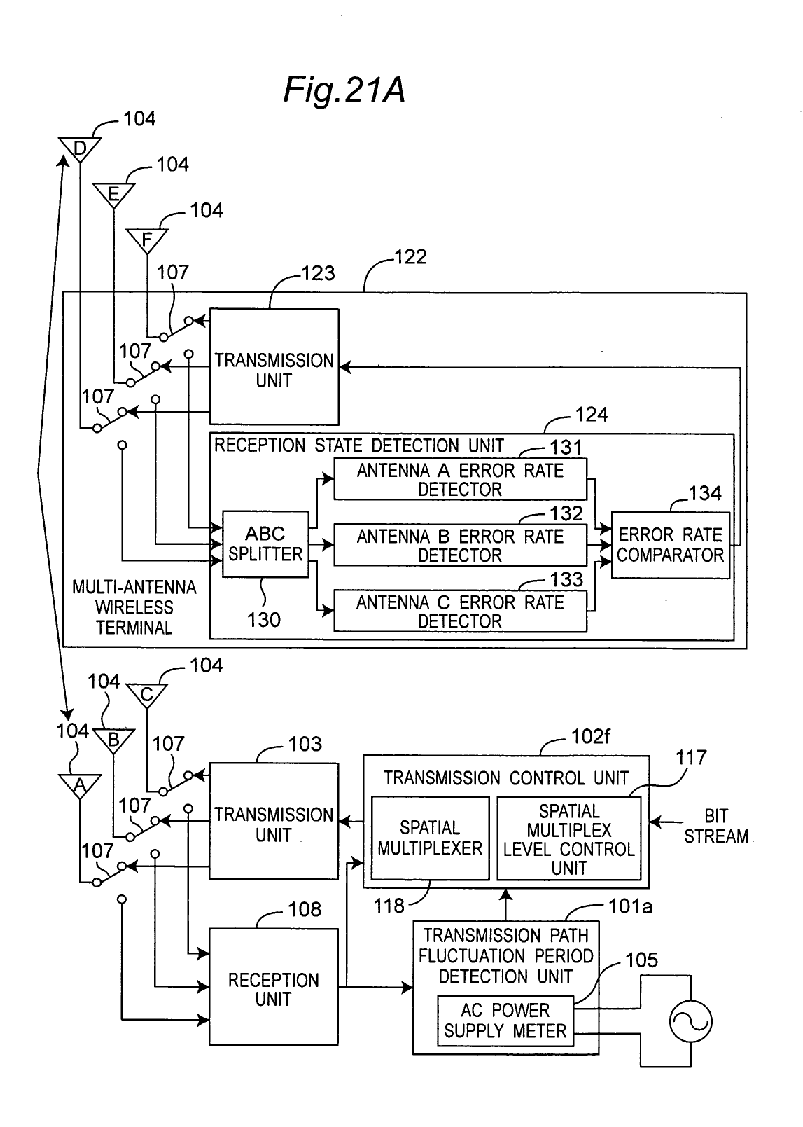

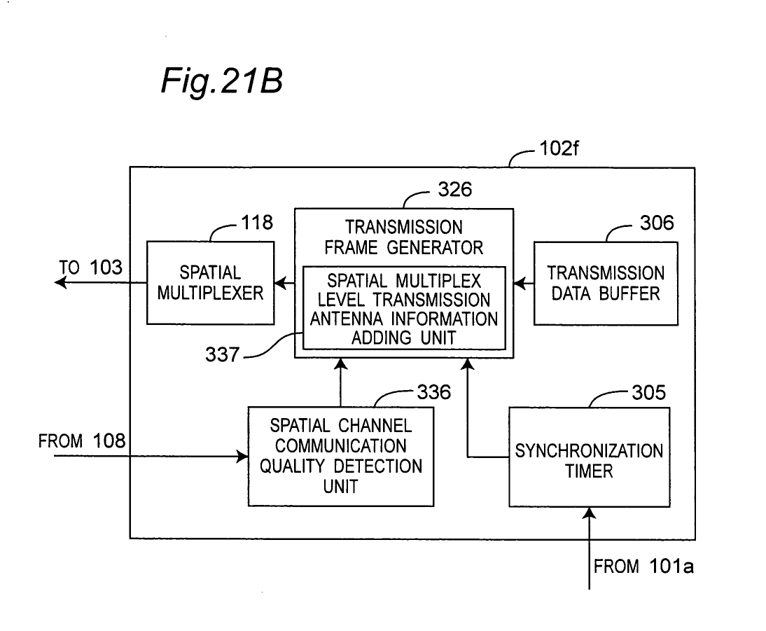

FIG. 21A is a block diagram showing the arrangement of a wireless communication apparatus according to a tenth embodiment of the invention.

As shown in FIG. 21A, a wireless communication apparatus according to this embodiment of the invention has a transmission path fluctuation period detection unit 101a, a transmission control unit 102f to which the transmission path fluctuation period signals Tv1 and Tv2 output by transmission path fluctuation period detection unit 101a are input, a transmission unit 103 to which the transmission signal output by transmission control unit 102f is input, a plurality of transmission/reception switches 107 which are each connected to the transmission unit 103 and switch the input/output signals during transmission and reception, a plurality of antennae 104 each connected to one of the plurality of transmission/reception switches 107, and a reception unit 108 that is connected to the multiple transmission/reception switches 107.

This embodiment of the invention has three antennae A, B, C, and a transmission/reception switch 107 connected to each of antennae A, B, C. The reception unit 108 receives wireless packets transmitted from another wireless terminal, and based on the received signal outputs information about reception from the destination wireless terminal to the transmission path fluctuation period detection unit 101a and transmission control unit 102f. An AC power supply meter 105 is also rendered inside the transmission path fluctuation period detection unit 101a and connected to the AC power source.

In addition, a spatial multiplex level control unit 117 for controlling the spatial multiplex level W (where W is 1, 2, or 3 in this embodiment of the invention) of the transmitted wireless signal, and a spatial multiplexer 118, are rendered inside the transmission control unit 102e. The spatial multiplexer 118 modulates the wireless signal according to the spatial multiplex level W of the transmission signals supplied from the spatial multiplex level control unit 117, and inserts the spatial multiplexing information in the wireless packets.

FIG. 21A also shows a multi-antenna wireless terminal 122 that communicates with a wireless communication apparatus according to this embodiment of the invention. This multi-antenna wireless terminal 122 has a transmission unit 123 for transmitting wireless packets, a plurality of transmission/reception switches 107 each connected to the transmission unit 123 for selecting the input/output signals during transmission and reception, a plurality of antennae 104 each connected to one of the plural transmission/reception switches 107, and a reception state detection unit 124 connected to each of the plural transmission/reception switches 107.

In this embodiment of the invention the multi-antenna wireless terminal 122 also has three antennae D, E, F, and one transmission/reception switch 107 is rendered for each of the antennae D, E, F.

The reception state detection unit 124 has an ABC splitter 130, an antenna A error rate detector 131, antenna B error rate detector 131, antenna C error rate detector 131, and an error rate comparator 134.

FIG. 21B is a block diagram of the transmission control unit 102f shown in FIG. 21A. Like elements in FIG. 21B and the first embodiment shown in FIG. 2C are identified by like reference numeral, and further detailed description thereof is omitted here.

Referring to FIG. 21B, this transmission control unit 102f has a synchronization timer 305, spatial channel communication quality detection unit 336, transmission frame generator 326, transmission data buffer 306, and spatial multiplexer 118. The transmission frame generator 326 has a spatial multiplex level transmission antenna information adding unit 337.

Operation of this embodiment of the invention is described next.

First, transmission control unit 102f generates a transmission signal with three channel spatial multiplexing, and the transmission unit 103 then outputs the first channel, second channel, and third channel signals from antennae A, B, C, respectively.

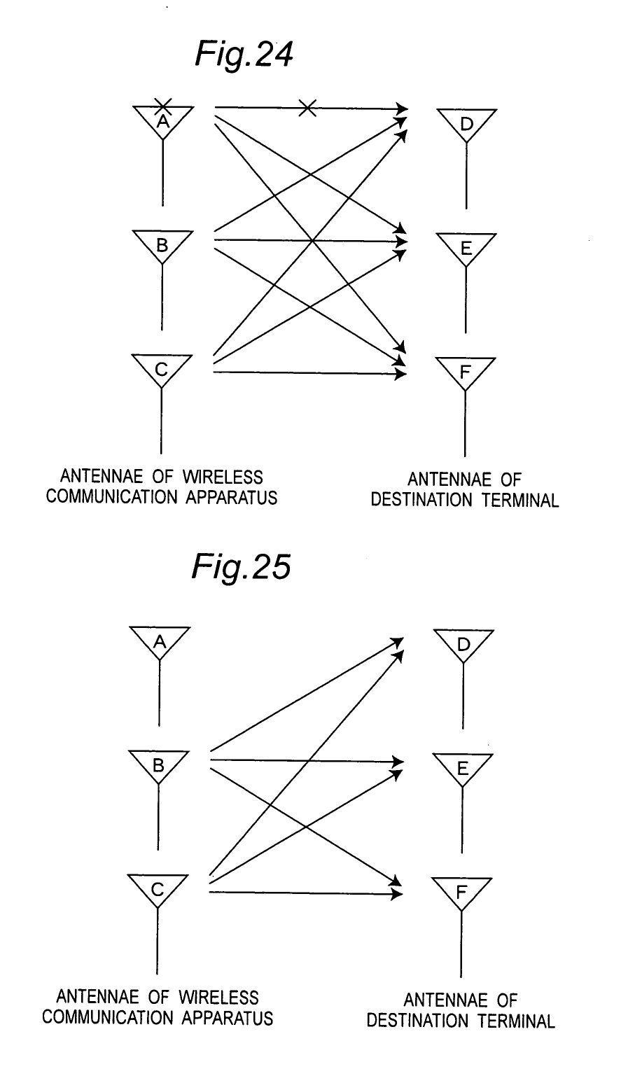

Next, as shown in FIG. 24, antenna D of multi-antenna wireless terminal 122 receives the first, second, and third channel transmission signals, antenna E also receives the first, second, and third channel transmission signals, and antenna F also receives the first, second, and third channel transmission signals. It is assumed below that transmission path fluctuation caused by discharge lamp fading affects the transmission path between antenna A and antenna D.

The ABC splitter 130 of reception state detection unit 124 then splits the reception signals from antennae D, E, F into the reception signal from antenna A, the reception signal from antenna B, and the reception signal from antenna C. The reception signal from antenna A is passed to antenna A error rate detector 131, which detects the error rate of the signal transmitted from antenna A. The reception signal from antenna B is passed to antenna B error rate detector 132, which detects the error rate of the signal transmitted from antenna B. The reception signal from antenna C is passed to antenna C error rate detector 133, which detects the error rate of the signal transmitted from antenna C.

The error rate comparator 134 compares the error rates output by error rate detectors 131, 132, 133 and determines the reception signal from antennae A, B, C that has the highest error rate. Alternatively, the error rate comparator 134 could compare the error rates supplied from error rate detectors 131, 132, 133 with a specific error rate and identify each antenna having an error rate greater than the specific error rate. It is assumed here that error rate comparator 134 determines that the error rate of the reception signal from antenna A is highest or is greater than the specified error rate.

In this case, error rate comparator 134 identifies antenna A as an antenna prohibited from use. More specifically, error rate comparator 134 indicates that of antennae A, B, C of the wireless communication apparatus according to this embodiment of the invention, the signal output from antenna A is easily subject to the effects of fading. This information that “antenna A is prohibited from use” is sent to transmission unit 123 and is written to the reception state packet 302 shown in FIG. 23. The wireless packet 302 shown in FIG. 23 has a header used for reception gain control or synchronization detection, and a reception state block, and is transmitted from the wireless terminal to the wireless communication apparatus according to this embodiment of the invention. In this case wireless packets output by the multi-antenna wireless terminal 122 do not need to be transmitted with spatial multiplexing.

This wireless communication apparatus passes the received packets to the reception unit 108 and then to the transmission control unit 102f. In the transmission control unit 102f the spatial channel communication quality detection unit 336 reads from the received packet the information that “antenna A is prohibited from use” and outputs this information to the transmission frame generator 326. The transmission frame generator 326 then determines based on the signal from synchronization timer 305 if the next transmitted packet is transmitted in transmission path fluctuation periods Tv1 and Tv2.

If the wireless packet transmission period overlaps a transmission path fluctuation period, data is read from transmission data buffer 306 to generate the transfer frames, but the signal is transmitted from an antenna other than the antenna prohibited from being used. In this example two spatial multiplexing channels are available and the transfer frames are generated using antenna B and antenna C. The spatial multiplex level transmission antenna information adding unit 337 adds the spatial multiplex level and transmission antenna information to the header of the transfer frame. The spatial multiplexer 118 then applies two-channel multiplexing and outputs to transmission unit 103 for transmission from antennae B and C. As shown in FIG. 20, the spatial multiplexer 118 adds a signal denoting the spatial multiplex level to packet 301. FIG. 25 shows the spatial channels when the wireless packet transmission period overlaps the transmission path fluctuation period.

Conversely, if the wireless packet transmission period does not overlap the transmission path fluctuation period, the antennas that can be used for spatially multiplexed transmission are not limited, and information enabling modulation using the highest possible spatial multiplex level is added to the header of the transmission frame and output to transmission unit 103.

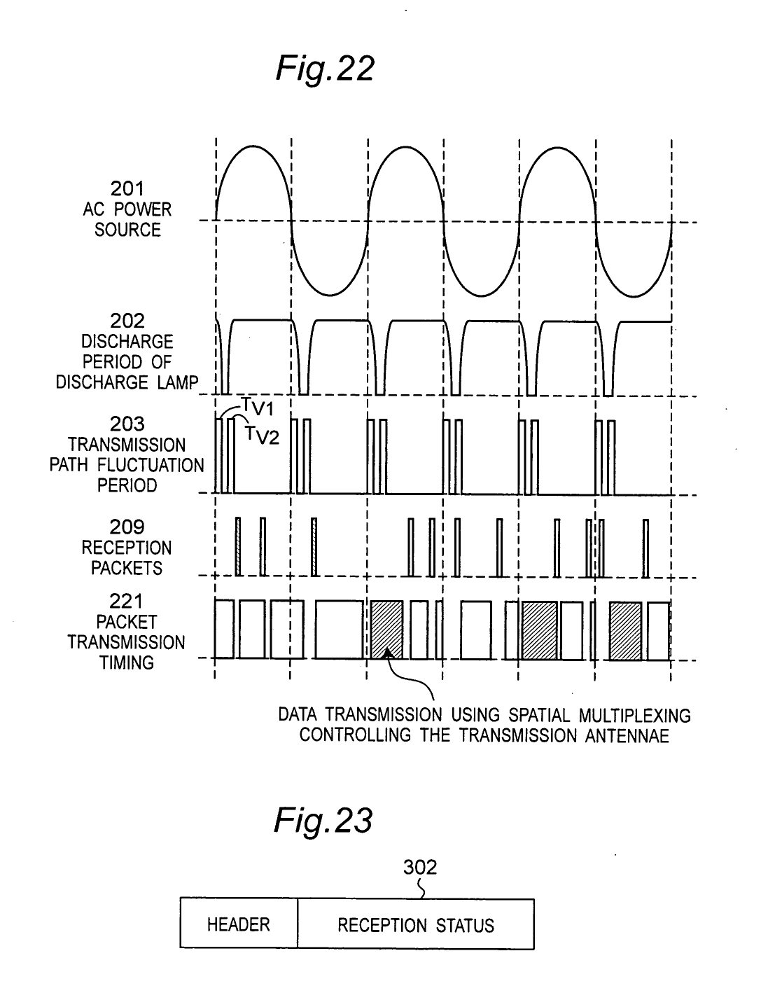

FIG. 22 is a waveform diagram with time on the horizontal axis describing the operation of the wireless communication apparatus according to this tenth embodiment of the invention.

Like elements and waveforms in FIG. 21A and FIG. 22 and in FIG. 2A and FIG. 2D according to the first embodiment described above are identified by like reference numerals, and further description thereof is omitted here.

In FIG. 22 reference numeral 209 denotes the packets that denote the reception condition of the destination wireless terminal 122 and are received by the wireless communication apparatus. Reference numeral 221 denotes the transmission timing and the number of channels used for spatial multiplexing of wireless packets transmitted by the wireless communication apparatus according to this embodiment of the invention.

More specifically, when wireless packets are transmitted during transmission path fluctuation periods Tv1 and Tv2 in a wireless communication apparatus according to this embodiment of the invention, the number of channels used for spatial multiplexing is limited to using for wireless packet transmission only antennae for which the effect of discharge lamp fading in the transmission path is small, and when the wireless packet are not transmitted in a transmission path fluctuation period, the wireless packets are transmitted by spatial multiplexing using the same number of channels as the wireless communication apparatus has antennae.

It should be noted that an AC power supply meter 105 is used in the transmission path fluctuation period detection unit 101a of a wireless communication apparatus according to this embodiment of the invention, but the same transmission path fluctuation period detection can also be achieved using a periodic signal generator 109 or photoelectric conversion unit 106.

A wireless communication apparatus according to this embodiment of the invention can strength resistance to fading by reducing the spatial multiplexing levels of the wireless packets at least in transmission path fluctuation periods Tv1 and Tv2. Communication data errors can thus be avoided.

The transmission control unit 102f in this tenth embodiment of the invention thus selects a restricted transmission mode in which data packets are transmitted using fewer than the maximum number of available antennae if the packet transmission period overlaps any part of transmission path fluctuation periods Tv1 and Tv2, and selects a normal transmission mode in which data packets are transmitted using as many antennae as possible if the packet transmission period does not overlap a transmission path fluctuation period.

### Embodiment 11

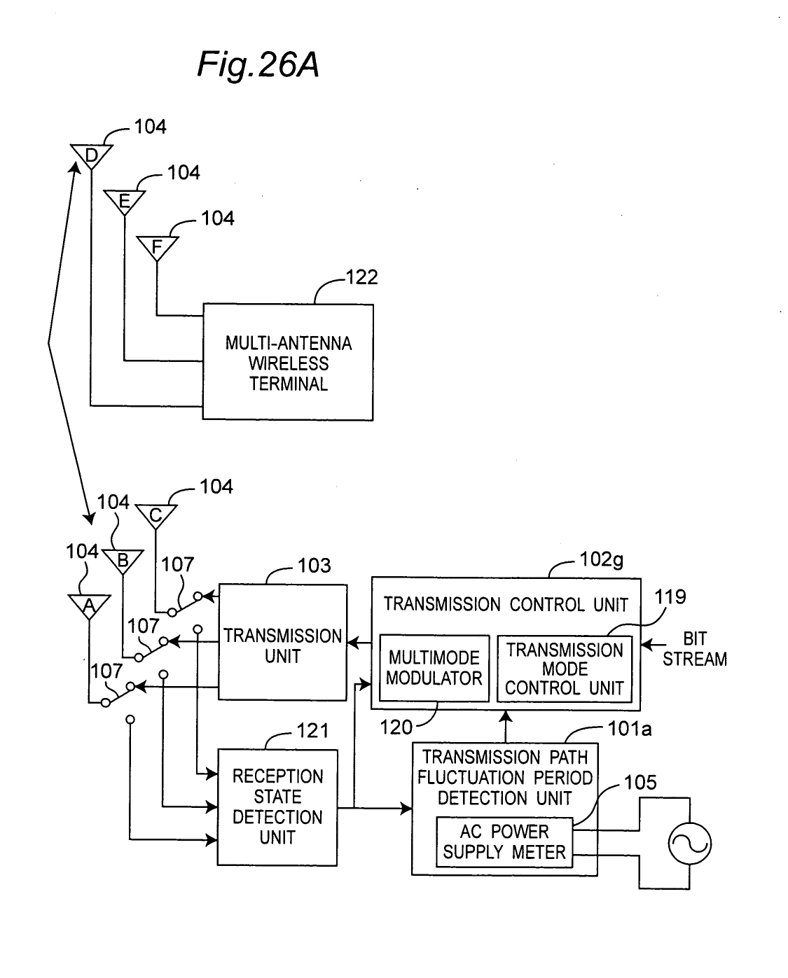

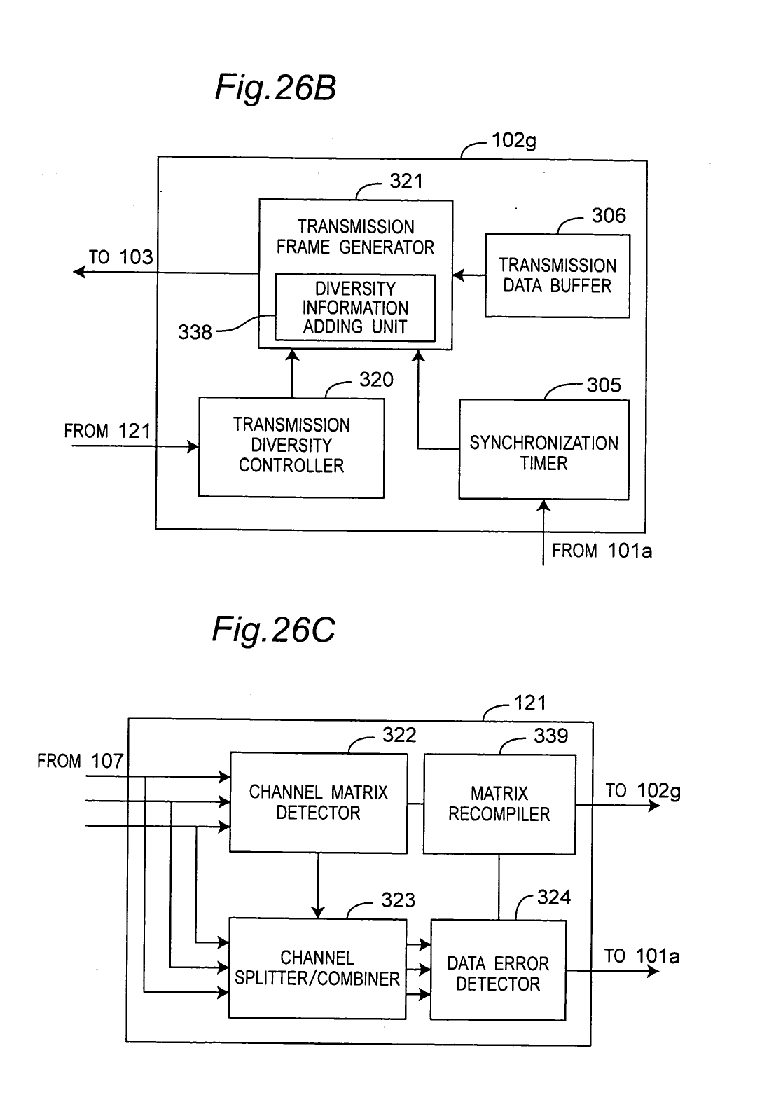

FIG. 26A is a block diagram showing the arrangement of a wireless communication apparatus according to an eleventh embodiment of the invention.

As shown in FIG. 26A, a wireless communication apparatus according to this embodiment of the invention has a transmission path fluctuation period detection unit 101a, a transmission control unit 102g to which the transmission path fluctuation period signals Tv1 and Tv2 output by transmission path fluctuation period detection unit 101a are input, a transmission unit 103 to which the transmission signal output by transmission control unit 102g is input, a plurality of transmission/reception switches 107 which are each connected to the transmission unit 103 and switch the input/output signals during transmission and reception, a plurality of antennae 104 each connected to one of the plurality of transmission/reception switches 107, and a reception state detection unit 121. The reception state detection unit 121 demodulates the spatial multiplexing of the received signal, and generates reception data error information for each channel or wireless transmission path information. This reception data error information or wireless transmission path information is output to transmission path fluctuation period detection unit 101 and transmission control unit 102. An AC power supply meter 105 is also rendered in the transmission path fluctuation period detection unit 101a.

Also rendered inside the transmission control unit 102g are transmission mode control unit 119 and multimode modulator 120. The transmission mode control unit 119 produces a modulation mode control signal determining whether the wireless signal to be transmitted is modulated by spatial multiplexing or as a transmission diversity signal. The multimode modulator 120 receives this modulation mode control signal and sets the transmission mode to a spatial multiplexing mode or transmission diversity mode, modulates the wireless signal accordingly, and inserts the spatial multiplexing information in the wireless packets.

The wireless communication apparatus of this embodiment communicates with a multi-antenna wireless terminal 122 have a plurality of antennae 104 as shown in FIG. 26A.

FIG. 26C is a block diagram more specifically showing the arrangement of the reception state detection unit 121 shown in FIG. 26A. The reception signals from the plural transmission/reception switches 107 shown in FIG. 26A are connected to the channel matrix detector 322 and channel splitter/combiner 323 shown in FIG. 26C. When a reception signal is input, the channel matrix detector 322 checks the preamble using the training signal added to the reception signal header, and thereby detects the spatial transmission path matrix denoting the spatial channel information for communication between the multiple antennae of the destination terminal and the multiple antennae of the wireless communication apparatus according to this embodiment of the invention. Based on this spatial transmission path matrix, the channel splitter/combiner 323 demodulates the data portion of the following reception signal and outputs the data on each of the multiple channels. A data error detector 324 checks for data errors in the data on each of the channels. The data error detector 324 outputs the result to the transmission path fluctuation period detection unit 101a in FIG. 26A and to the matrix recompiler 339. The matrix recompiler 339 recompiles the spatial transmission path matrix output by channel matrix detector 322 based on the error detection result output by data error detector 324, and outputs the recompiled spatial transmission path matrix. Operation when transmission path fluctuation caused by discharge lamp fading is high on the transmission path from antenna D to antenna A is described below.

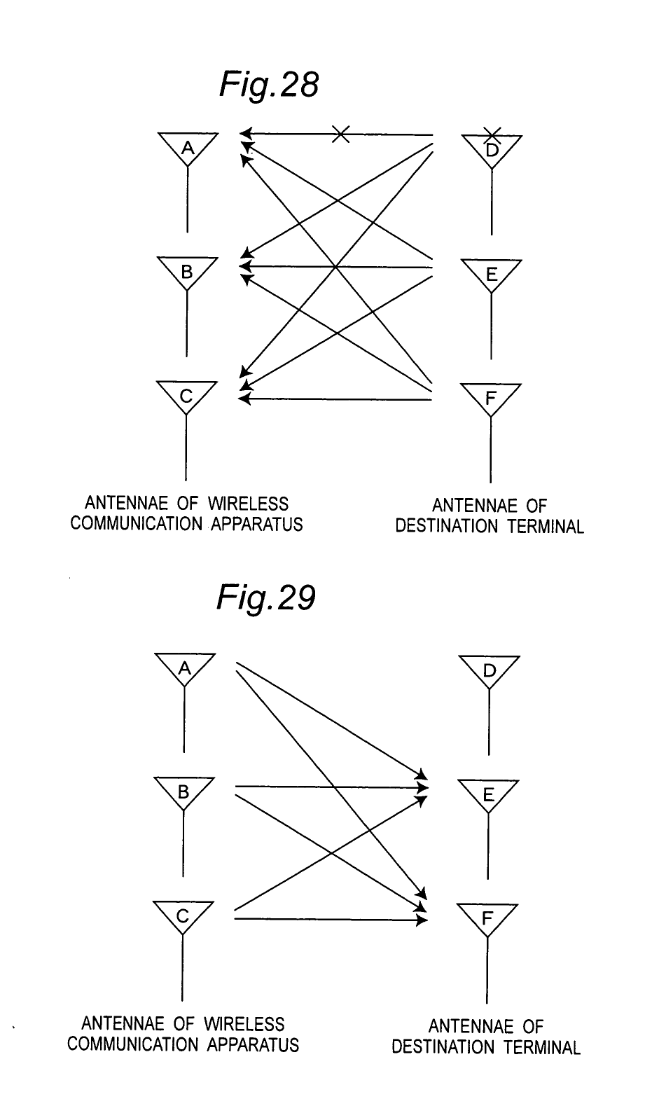

FIG. 28 shows the state of spatial channels at this time. In FIG. 28 A, B, and C denote the antennae of the wireless communication apparatus of the invention, and D, E, and F denote the antennae of the destination multi-antenna wireless terminal 122. Because transmission path fluctuation on the transmission path from antenna D to antenna A is high due to discharge lamp fading, the data error detector 324 of the reception state detection unit 121 in this wireless communication apparatus detects that the quality of the channel signals transmitted from antenna D is degraded in the reception packets received during the transmission path fluctuation period. The data error detector 324 can also detect that communication of the channel signals transmitted from antenna E and antenna F is not affected during the transmission path fluctuation period, and can also detect transmission path information for output from antennae E and F to the antennae A, B, C of this wireless communication apparatus.

FIG. 26B is a block diagram of the transmission control unit 102 shown in FIG. 26A. Like elements in FIG. 26B and the first embodiment shown in FIG. 2C are identified by like reference numeral, and further detailed description thereof is omitted here.

In FIG. 26B, the synchronization timer 305 receives the transmission path fluctuation period signal from the transmission path fluctuation period detection unit 101a shown in FIG. 12A and outputs how much time there is when there is no transmission path fluctuation until transmission path fluctuation occurs again. Note that the transmission control unit in a wireless communication apparatus according to this embodiment of the invention has a transmission diversity controller 320 as shown in FIG. 26B.

The transmission diversity controller 320 gets the spatial transmission path matrix recompiled and output by the matrix recompiler 339 shown in FIG. 26C, and determines which signals transmitted from antennae D, E, F of the destination wireless terminal are easily subject to fading. It is assumed here that signals transmitted from antenna D are subject to fading. The transmission diversity controller 320 then determines the transmission diversity coefficient enabling spatial multiplexed communication instead of prohibiting using the particular antenna D. This transmission diversity coefficient is then output to the transfer frame generator 321.

When data is received from transmission data buffer 306, transfer frame generator 321 determines based on the signal from synchronization timer 305 whether the next transmitted packet will be transmitted in transmission path fluctuation periods Tv1 and Tv2.

If the wireless packet transmission period overlaps the transmission path fluctuation period, data is read from the transmission data buffer based on the transmission diversity coefficient supplied from the transmission diversity controller 320, the wireless signal is processed for transmission using transmission diversity. The diversity information adding unit 338 also adds diversity information to the frame header, and then outputs the transmission frames to the transmission unit 103. The transmission paths when signals from antenna D are identified as subject to fading are shown in FIG. 29. FIG. 29 shows transmission when signals are modulated with transmission diversity based on the recompiled spatial transmission path matrix in the transmission path fluctuation period, and the wireless packets are transmitted on two spatial multiplex levels from antennae A, B, C to antennae E and F over transmission paths where this is little path interference. More specifically, the wireless packets are transmitted so that the reception power is greater at antennae E and F, or so that the correlation between antenna E and antenna F is reduced for greater spatial channel separation.

If the wireless packet transmission period does not overlap the transmission path fluctuation period, the wireless signals do not necessarily need to be transmitted using transmission diversity, the transfer frame generator 321 therefore applies a normal spatial multiplex modulation process, and diversity information adding unit 338 adds information indicating modulation by a normal spatial multiplex process to the header of the transmission frame.

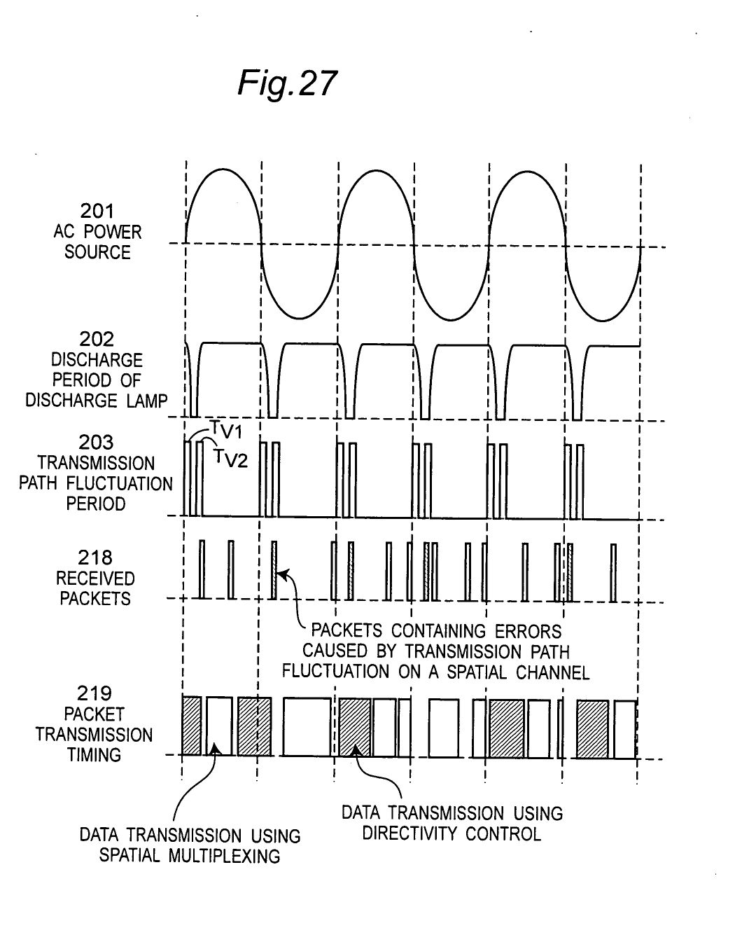

FIG. 27 is a waveform diagram with time on the horizontal axis describing the operation of the wireless communication apparatus according to this eleventh embodiment of the invention.

Like elements and waveforms in FIG. 26A and FIG. 27 and in FIG. 2A and FIG. 2D according to the first embodiment described above are identified by like reference numerals, and further description thereof is omitted here.

In FIG. 27 reference numeral 218 indicates the packets received by the wireless communication apparatus. The received packets include packets containing data errors in part of the spatial channels due to sudden transmission path interference caused by discharge lamp fading. The reception state detection unit 121 outputs to the transmission path fluctuation period detection unit 101 whether data errors were detected in the received packets. Reference numeral 219 denotes the transmission timing and number of spatial multiplexing channels used for the wireless packets transmitted by the wireless communication apparatus according to this embodiment of the invention. The wireless communication apparatus according to this embodiment of the invention transmits wireless packets using directivity-controlled transmission diversity if the transmitted wireless packets overlap a transmission path fluctuation period, and transmits wireless packets using spatial multiplexing if the wireless packet transmission period does not overlap a transmission path fluctuation period.

A wireless communication apparatus according to this embodiment of the invention can thus improve resistance to fading in the transmission path fluctuation periods Tv1 and Tv2 by controlling the directivity of the wireless packets by means of transmission diversity. As a result, communication data errors can be avoided.

The transmission control unit 102g in this eleventh embodiment of the invention thus selects a restricted transmission mode in which data packets are transmitted with controlled directivity by means of transmission diversity if the packet transmission period overlaps any part of transmission path fluctuation periods Tv1 and Tv2, and selects a normal transmission mode in which data packets are transmitted using as many spatial multiplex levels as possible without limitation if the packet transmission period does not overlap a transmission path fluctuation period.

### APPLICATION IN INDUSTRY

A wireless communication apparatus according to the present invention can be used in wireless LAN equipment, for example.

What is claimed is:

1. A wireless communication apparatus comprising:
a transmission path fluctuation period detection unit for detecting a transmission path fluctuation period in which transmission path fluctuation caused by a discharge lamp is greater than other in other periods; and
a transmission control unit that packetizes a bit stream and selectively operates in a normal transmission mode that does not restrict packet transmissions or in a restricted transmission mode that restricts packet transmissions;
wherein the transmission control unit selects the restricted transmission mode when the packet transmission period at least overlaps the transmission path fluctuation period, and selects the normal transmission mode when the packet transmission period does not overlap the transmission path fluctuation period.

2. A wireless communication apparatus as described in claim 1, wherein the transmission path fluctuation period detection unit comprises an AC power supply measuring unit for detecting the voltage or current level of the AC power source, and the transmission path fluctuation period is detected based on change in the voltage or current.

3. A wireless communication apparatus as described in claim 1, wherein transmission path fluctuation period detection unit comprises a photoelectric conversion unit which generates an electric signal from ambient light around the wireless communication apparatus, and the transmission path fluctuation period is detected based on change in output from the photoelectric conversion unit.

4. A wireless communication apparatus as described in claim 1, wherein the transmission path fluctuation period detection unit comprises a means of detecting a rising period and falling period of light output by a discharge lamp, and at least the rising period and falling period are detected as the transmission path fluctuation period.

5. A wireless communication apparatus as described in claim 1, wherein the transmission path fluctuation period detection unit comprises a means of detecting an error rate distribution for the received data, and the transmission path fluctuation period is detected based on the error rate distribution.

6. A wireless communication apparatus as described in claim 1, wherein the transmission path fluctuation period detection unit comprises a normal transmission confirmation unit that receives a reception confirmation signal output by a destination terminal in response to a wireless signal transmitted from the wireless communication apparatus and detects if the transmitted wireless signal was correctly received by the destination terminal, and the transmission path fluctuation period is detected based on the output signal from the normal transmission confirmation unit.

7. A wireless communication apparatus as described in claim 1, wherein the restricted transmission mode is a mode in which signals are not transmitted.

8. A wireless communication apparatus as described in claim 1, wherein the restricted transmission mode is a mode in which data packets are transmitted at a low rate.

9. A wireless communication apparatus as described in claim 1, wherein the restricted transmission mode is a mode in which data packets are transmitted to a specific predetermined terminal.

10. A wireless communication apparatus as described in claim 1, wherein the restricted transmission mode is a mode in which data packets are transmitted to a specific terminal determined from an accumulated error rate.

11. A wireless communication apparatus as described in claim 1, wherein the restricted transmission mode is a mode in which data packets are transmitted using few spatial multiplex levels or without multiplexing.

12. A wireless communication apparatus as described in claim 1, wherein the restricted transmission mode is a mode in which data packets are transmitted using fewer antennas than the maximum number of possible antennas.

13. A wireless communication apparatus as described in claim 1, wherein the restricted transmission mode is a mode in which data packets are transmitted with directivity control by means of transmission diversity.

14. A wireless communication apparatus as described in claim 11, wherein data denoting the spatial multiplex level is inserted in and transmitted with the wireless packets.

15. A wireless communication method comprising steps of:
detecting a transmission path fluctuation period in which transmission path fluctuation caused by a discharge lamp is greater than other in other periods; and
packetizing a bit stream and selecting a normal transmission mode that does not restrict packet transmissions or a restricted transmission mode that restricts packet transmissions;
wherein the restricted transmission mode is selected when the packet transmission period at least overlaps the transmission path fluctuation period, and the normal transmission mode is selected when the packet transmission period does not overlap the transmission path fluctuation period.

16. A wireless communication method as described in claim 15, further comprising an AC power supply measuring unit for detecting the voltage or current level of the AC power source, wherein the transmission path fluctuation period is detected based on change in the voltage or current.

17. A wireless communication method as described in claim 15, further comprising a photoelectric conversion unit which generates an electric signal from ambient light around the wireless communication apparatus, wherein the transmission path fluctuation period is detected based on change in output from the photoelectric conversion unit.

18. A wireless communication method as described in claim 15, further comprising a means of detecting a rising period and falling period of light output by a discharge lamp, wherein at least the rising period and falling period are detected as the transmission path fluctuation period.

19. A wireless communication method as described in claim 15, further comprising a means of detecting an error rate distribution for the received data, wherein the transmission path fluctuation period is detected based on the error rate distribution.

20. A wireless communication method as described in claim 15, further comprising a normal transmission confirmation unit that receives a reception confirmation signal output by a destination terminal in response to a wireless signal transmitted from the wireless communication apparatus and detects if the transmitted wireless signal was correctly received by the destination terminal, wherein the transmission path fluctuation period is detected based on the output signal from the normal transmission confirmation unit.

21. A wireless communication method as described in claim 15, wherein the restricted transmission mode is a mode in which signals are not transmitted.

22. A wireless communication method as described in claim 15, wherein the restricted transmission mode is a mode in which data packets are transmitted at a low rate.

23. A wireless communication method as described in claim 15, wherein the restricted transmission mode is a mode in which data packets are transmitted to a specific predetermined terminal.

24. A wireless communication method as described in claim 15, wherein the restricted transmission mode is a mode in which data packets are transmitted to a specific terminal determined from an accumulated error rate.

25. A wireless communication method as described in claim 15, wherein the restricted transmission mode is a mode in which data packets are transmitted using few spatial multiplex levels or without multiplexing.

26. A wireless communication method as described in claim 15, wherein the restricted transmission mode is a mode in which data packets are transmitted using fewer antennas than the maximum number of possible antennas.

27. A wireless communication method as described in claim 15, wherein the restricted transmission mode is a mode in which data packets are transmitted with directivity control by means of transmission diversity.

28. A wireless communication method as described in claim 25, wherein data denoting the spatial multiplex level is inserted in and transmitted with the wireless packets.
